(19) United States
(12) Patent Application Publication
(10) Pub. No.: US 2025/0267663 A1
(43) Pub. Date: Aug. 21, 2025

(54) OPERATION METHOD OF TERMINAL, AND TERMINAL APPARATUS FOR THE SAME

(71) Applicant: ELECTRONICS AND TELECOMMUNICATIONS RESEARCH INSTITUTE, Daejeon (KR)

(72) Inventors: Cheul Soon KIM, Daejeon (KR); Jae Heung KIM, Daejeon (KR); Sung Hyun MOON, Daejeon (KR); Jung Hoon LEE, Daejeon (KR); Sung Cheol CHANG, Daejeon (KR)

(73) Assignee: ELECTRONICS AND TELECOMMUNICATIONS RESEARCH INSTITUTE, Daejeon (KR)

(21) Appl. No.: 19/197,121

(22) Filed: May 2, 2025

Related U.S. Application Data
(63) Continuation of application No. 17/592,505, filed on Feb. 3, 2022.

(30) Foreign Application Priority Data
Feb. 4, 2021 (KR) 10-2021-0016370
Feb. 19, 2021 (KR) 10-2021-0022849
May 27, 2021 (KR) 10-2021-0068568
Aug. 6, 2021 (KR) 10-2021-0104110
Sep. 24, 2021 (KR) 10-2021-0126759
Oct. 1, 2021 (KR) 10-2021-0131186
Jan. 11, 2022 (KR) 10-2022-0004346
Feb. 3, 2022 (KR) 10-2022-0014010

(51) Int. Cl. H04W 72/1273; H04L 1/1812; H04L 5/00; H04W 72/0446; H04W 72/23

(52) U.S. Cl. CPC H04W 72/1273; H04L 1/1812; H04L 5/0053; H04W 72/0446; H04W 72/23

(57) ABSTRACT

An operation method of a terminal in a communication system may comprise: receiving, from a base station, an SPS PDSCH; receiving a first PDSCH from the base station; generating SPS HARQ ACK/NACK information for the SPS PDSCH; generating first HARQ ACK/NACK information for the first PDSCH; and when the SPS HARQ-ACK/NACK information is not transmitted in a first slot and transmission of the SPS HARQ-ACK/NACK information is deferred, transmitting both the SPS HARQ ACK/NACK information and the first HARQ ACK/NACK information in a second slot after the first slot.

### CROSS-REFERENCE TO RELATED APPLICATIONS

This application is a continuation of U.S. application Ser. No. 17/592,505 filed on Feb. 3, 2022, and claims priority to Korean Patent Applications No. 10-2021-0016370 filed on Feb. 4, 2021, No. 10-2021-0022849 filed on Feb. 19, 2021, No. 10-2021-0068568 filed on May 27, 2021, No. 10-2021-0104110 filed on Aug. 6, 2021, No. 10-2021-0126759 filed on Sep. 24, 2021, No. 10-2021-0131186 filed on Oct. 1, 2021, No. 10-2022-0004346 filed on Jan. 11, 2022, and No. 10-2022-0014010 filed on Feb. 3, 2022, with the Korean Intellectual Property Office (KIPO), the entire contents of which are hereby incorporated by reference.

### BACKGROUND

### 1. Technical Field

The present disclosure relates to an operation method of a terminal, and more particularly, to a signal transmission method of a low-cost terminal or a terminal having reduced capability (i.e., RedCap terminal), and a terminal apparatus for the same.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The 5G communication system (e.g., communication system supporting the NR) using a higher frequency band (e.g., frequency band of 6 GHz or above) than a frequency band (e.g., frequency band of 6 GHz or below) of the 4G communication system is being considered for processing of wireless data soaring after commercialization of the 4G communication system (e.g., communication system supporting the LTE). The 5G communication system can support enhanced mobile broadband (eMBB), ultra-reliable low-latency communication (URLLC), massive machine type communication (mMTC), and the like.

In addition, a time sensitive communication (TSC) scenario may be considered. In particular, the mMTC, URLLC, and TSC may be applied to an Internet of Things (IoT) scenario. One network should be able to support all or some of the scenarios described above. The mMTC scenario may be determined to satisfy the IMT-2020 requirements using NB-IoT and LTE-MTC, but a lot of further discussion is needed to satisfy the URLLC scenario.

### SUMMARY

Accordingly, exemplary embodiments of the present disclosure are directed to providing an operation method of a terminal.

Accordingly, exemplary embodiments of the present disclosure are also directed to providing an operation method of a base station.

Accordingly, exemplary embodiments of the present disclosure are also directed to providing a configuration of a terminal apparatus for performing the operation method of the terminal.

According to an exemplary embodiment of the present disclosure, an operation method of a terminal may comprise: receiving, from a base station, a semi-persistent scheduling (SPS) physical downlink shared channel (PDSCH); receiving a first PDSCH from the base station; generating SPS hybrid automatic repeat request (HARQ) acknowledgment (ACK)/negative ACK (NACK) information for the SPS PDSCH; generating first HARQ ACK/NACK information for the first PDSCH; and when the SPS HARQ-ACK/NACK information is not transmitted in a first slot and transmission of the SPS HARQ-ACK/NACK information is deferred, transmitting both the SPS HARQ ACK/NACK information and the first HARQ ACK/NACK information in a second slot after the first slot.

The first slot may be a transmission slot of the SPS HARQ-ACK/NACK information according to a periodicity based on an SPS configuration for the SPS PDSCH.

The operation method may further comprise receiving, from the base station, information on a maximum deferral time of the transmission the SPS HARQ-ACK/NACK information.

A time interval between the first slot and the second slot may be within the maximum deferral time.

When the transmission of the SPS HARQ-ACK/NACK information is deferred until after the maximum deferral time, the SPS HARQ-ACK/NACK information may not be transmitted.

A first HARQ codebook including the SPS HARQ-ACK/NACK information and a second HARQ codebook including the first HARQ ACK/NACK information may be concatenated and transmitted as one codebook in the second slot.

The first HARQ codebook and the second HARQ codebook may correspond to a same priority index.

The SPS HARQ-ACK/NACK information may be arranged within the first HARQ codebook based on an order in which the SPS PDSCH is received by the terminal.

The first PDSCH may be a PDSCH dynamically scheduled by the base station.

According to another exemplary embodiment of the present disclosure, an operation method of a base station may comprise: transmitting, to a terminal, a semi-persistent scheduling (SPS) physical downlink shared channel (PDSCH); transmitting a first PDSCH to the terminal;

and when SPS hybrid automatic repeat request (HARQ) acknowledgment (ACK)/negative ACK (NACK) information for the SPS PDSCH is not received from the terminal in a first slot and reception of the SPS HARQ-ACK/NACK information is deferred, receiving both the SPS HARQ ACK/NACK information and first HARQ ACK/NACK information for the first PDSCH in a second slot after the first slot.

The first slot may be a transmission slot of the SPS HARQ-ACK/NACK information according to a periodicity based on an SPS configuration for the SPS PDSCH.

The operation method may further comprise transmitting, to the terminal, information on a maximum deferral time of the reception the SPS HARQ-ACK/NACK information.

A time interval between the first slot and the second slot may be within the maximum deferral time.

When the reception of the SPS HARQ-ACK/NACK information is deferred until after the maximum deferral time, the SPS HARQ-ACK/NACK information may not be received.

A first HARQ codebook including the SPS HARQ-ACK/NACK information and a second HARQ codebook including the first HARQ ACK/NACK information may be concatenated and received as one codebook in the second slot.

The first HARQ codebook and the second HARQ codebook may correspond to a same priority index.

According to yet another exemplary embodiment of the present disclosure, a terminal may comprise: a processor; a memory electronically communicating with the processor; and instructions are stored in the memory, wherein when executed by the processor, the instructions cause the terminal to: receive, from a base station, a semi-persistent scheduling (SPS) physical downlink shared channel (PDSCH); receive a first PDSCH from the base station; generate SPS hybrid automatic repeat request (HARQ) acknowledgment (ACK)/negative ACK (NACK) information for the SPS PDSCH; generate first HARQ ACK/NACK information for the first PDSCH; and when the SPS HARQ-ACK/NACK information is not transmitted in a first slot and transmission of the SPS HARQ-ACK/NACK information is deferred, transmit both the SPS HARQ ACK/NACK information and the first HARQ ACK/NACK information in a second slot after the first slot.

The instructions may further cause the terminal to receive, from the base station, information on a maximum deferral time of the transmission the SPS HARQ-ACK/NACK information, and a time interval between the first slot and the second slot may be within the maximum deferral time.

A first HARQ codebook including the SPS HARQ-ACK/NACK information and a second HARQ codebook including the first HARQ ACK/NACK information may be concatenated and transmitted as one codebook in the second slot.

The SPS HARQ-ACK/NACK information may be arranged within the first HARQ codebook based on an order in which the SPS PDSCH is received by the terminal.

According to the exemplary embodiments of the present disclosure, various operation methods of a RedCap terminal may be provided. When the exemplary embodiments of the present disclosure are used, communication performance can be guaranteed even in the RedCap terminal having low complexity and low cost. Accordingly, the overall performance of the system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating an exemplary embodiment of transmitting a PUSCH instance according to a rate matching resource when the PUSCH repetition type A is configured (or indicated).

FIG. 4 is a conceptual diagram illustrating an exemplary embodiment in which rate matching is performed by applying invalid symbol(s) when the PUSCH repetition type B is configured (or indicated).

FIG. 5 is a conceptual diagram illustrating an exemplary embodiment in which rate matching is performed by applying invalid symbol(s) and a gap before the invalid symbol(s) when the PUSCH repetition type B is configured (or indicated).

FIG. 6 is a conceptual diagram illustrating an exemplary embodiment in which rate matching is performed by applying an invalid symbol pattern and gaps before and after the invalid symbol pattern when the PUSCH repetition type B is configured (or indicated).

FIG. 7 is an exemplary embodiment in which a PUSCH instance is transmitted by applying a DL signal/channel and gaps before and after the DL signal/channel when the PUSCH repetition type B is configured (or indicated).

FIG. 8 is a conceptual diagram illustrating an exemplary embodiment of reflecting an invalid resource to a PUCCH occasion.

FIG. 9 is a conceptual diagram illustrating an exemplary embodiment in which an invalid resource is not reflected to a time window of a PUCCH occasion and the invalid resource is reflected to transmission of a PUCCH instance.

FIG. 10 is a conceptual diagram illustrating an exemplary embodiment in which an invalid resource is reflected to a time window of a PUCCH occasion and transmission of a PUCCH instance.

FIG. 11 is a conceptual diagram illustrating an exemplary embodiment in which a modulated code block belongs to only one PDSCH/PUSCH instance.

FIG. 12 is a conceptual diagram illustrating an exemplary embodiment in which a modulated code block belongs to two PDSCH/PUSCH instances.

FIG. 13 is a conceptual diagram illustrating an exemplary embodiment in which a PDSCH/PUSCH is allocated to cross a boundary of a slot.

FIGS. 14A and 14B are conceptual diagrams illustrating an exemplary embodiment in which a PUSCH instance is dropped and a PUCCH is transmitted.

FIGS. 15A and 15B are conceptual diagrams illustrating an exemplary embodiment (‘per PUSCH instance’) in which UCI is multiplexed in a PUSCH instance overlapping a PUCCH, and

FIGS. 16A and 16B are conceptual diagram illustrating another exemplary embodiment (‘per PUSCH occasion’ or ‘per TBoMS’) in which UCI is multiplexed in a PUSCH instance overlapping a PUCCH.

FIG. 17 is a conceptual diagram illustrating an exemplary embodiment of receiving a DL RS or transmitting a UL RS in RB(s) not belonging to an activated BWP.

FIG. 18 is a conceptual diagram illustrating an exemplary embodiment of a configuration of resource allocation in which DL transmission and UL reception can be performed in FL symbols of a specific slot.

FIG. 19 is a conceptual diagram illustrating an exemplary embodiment in which characteristics of subcarriers are represented in a bitmap with respect to consecutive non-DL symbols.

FIG. 20 is a conceptual diagram illustrating an exemplary embodiment in which frequency hopping is not performed in the case of PUSCH repetition type B.

FIG. 21 is a conceptual diagram illustrating an exemplary embodiment in which frequency hopping is performed in an inter-repetition scheme in the case of PUSCH repetition type B.

FIG. 22 is a conceptual diagram illustrating an exemplary embodiment in which frequency hopping is performed in an intra-repetition scheme in the case of PUSCH repetition type B.

FIG. 23 is a conceptual diagram illustrating an exemplary embodiment in which frequency hopping is not performed in the case of PUSCH repetition type A or PUCCH repetition.

FIG. 24 is a conceptual diagram illustrating an exemplary embodiment in which frequency hopping is performed in an inter-slot hopping scheme in the case of PUSCH repetition type A or PUCCH repetition.

FIG. 25 is a conceptual diagram illustrating an exemplary embodiment in which frequency hopping is performed in an intra-slot hopping scheme in the case of PUSCH repetition type A or PUCCH repetition.

FIG. 26 is a conceptual diagram illustrating an exemplary embodiment in which a CORESET is received.

FIG. 27 is a conceptual diagram illustrating a first exemplary embodiment in which an SPS HARQ codebook is generated.

FIG. 28 is a conceptual diagram illustrating a second exemplary embodiment in which an SPS HARQ codebook is generated.

FIG. 29 is a conceptual diagram illustrating an exemplary embodiment of a time resource in which an SPS HARQ-ACK can be transmitted.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be a 4G communication network (e.g., a long-term evolution (LTE) communication system or an LTE-advanced (LTE-A) communication system), a 5G communication network (e.g., a new radio (NR) communication system), or the like. The 4G communication system may support communication in a frequency band of 6 GHz or below. The 5G communication system may support communication in a frequency band of 6 GHz or above, as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network. The ‘LTE’ may refer to the 4G communication system, LTE communication system, or LTE-A communication system, and the ‘NR’ may refer to the 5G communication system or NR communication system.

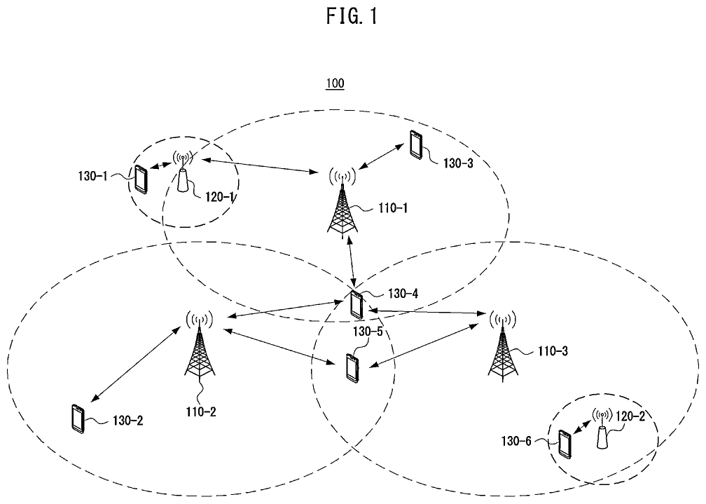

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g., serving-gateway (S-GW), packet data network (PDN)-gateway (P-GW), and mobility management entity (MME)). When the communication system 100 is the 5G communication system (e.g., NR system), the core network may include an access and mobility management function (AMF), a user plane function (UPF), a session management function (SMF), and the like.

The plurality of communication nodes 110 to 130 may support the communication protocols (e.g., LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may have the following structure.

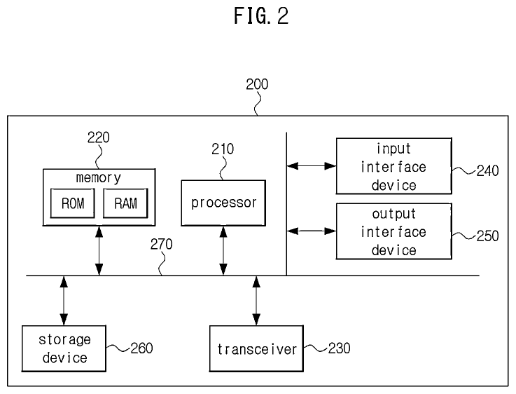

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), an advanced base station (BTS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), a macro cell, a pico cell, a micro cell, a femto cell, or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Hereinafter, operation methods of a terminal will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

As scenarios to which mobile communication is applied, enhanced mobile broadband (eMBB), massive machine-type communication (mMTC), and ultra-reliable and low latency communication (URLLC) may be considered. In addition, a time sensitive communication (TSC) scenario may be considered. In particular, the mMTC, URLLC, and TSC may be applied to an Internet of Things (IoT) scenario. One network should be able to support all or some of the scenarios described above. The mMTC scenario may be determined to satisfy the IMT-2020 requirements using NB-IoT and LTE-MTC, but a lot of further discussion is needed to satisfy the URLLC scenario.

In order to reduce an error rate of data, a low modulation and coding scheme (MCS) may be applied. However, in order not to increase a size of a field indicating an MCS in downlink control information (DCI), an MCS table may be configured using frequently used MCSs instead of using all possible MCSs. In order to apply a lower MCS than the MCSs supported by the MCS table, repeated transmission may be supported. In case of applying a QPSK which is the lowest modulation rate, the effect of further reducing the code rate can be achieved. In particular, since a transmission power is limited in case of uplink, repetition in the time domain may be used rather than repetition in the frequency domain.

In case of eMBB traffic and URLLC traffic supported by the 5G system, a lower MCS may be required for different purposes, respectively. For example, for eMBB traffic, a lower MCS may be required to extend a coverage. On the other hand, for URLLC traffic, a lower MCS may be required to reduce a latency and achieve a lower error rate. Since the requirements are different, in case of eMBB traffic, repeated transmission may be utilized even with a relatively large latency. On the other hand, in case of URLLC traffic, new MCSs may be introduced and applied to DCI/RRC rather than repeated transmission.

In order to support repeated transmission in the time domain for eMBB traffic, PUSCH repetition (or PUSCH repetition type A) has been introduced. In the PUSCH repetition type A, a PUSCH (or PUSCH mapping type A) allocated on a slot basis may be repeatedly transmitted. The PUSCH repetition type A corresponds to a configuration using time resource allocation over several slots in order to enhance the coverage. A DCI (e.g., in case of a type 2 configured grant and a dynamic grant) or RRC signaling (in case of a type 1 configured grant) may indicate only a time resource used for transmission in a first slot, and RRC signaling may indicate the number of repeated transmissions, so that time resources used for the PUSCH repetition type A are determined.

The repeated transmission for URLLC traffic is not appropriate because it causes a latency. However, when a sufficiently low MCS is applied, it is possible to reduce a latency due to decoding. When a sufficiently low MCS is applied, the number of resource elements (REs) to which data and/or control information are mapped increases, and a latency may occur because a base station (i.e., decoder of the base station) should wait until all the REs are received. However, if a PUSCH to which a rather high MCS is applied is repeatedly transmitted, the base station may succeed in decoding only with some REs. Therefore, even when the repeated transmission is applied, a time at which the decoding is successful may be earlier than when a lower MCS is applied in single transmission. In order to reduce the latency due to the repeated transmission (to prevent unnecessary latency to application of the PUSCH repetition type A), a PUSCH repetition type B which is a configuration in which a PUSCH allocated on a mini-slot basis (i.e., PUSCH mapping type B) is repeatedly transmitted has been introduced. By indicating a combination of a reference time resource that one PUSCH instance has and the number of repeated transmissions by using a DCI (in case of a type 2 configured grant and a dynamic grant) or RRC signaling (in case of a type 1 configured grant), time resources used for the PUSCH repetition type B may be determined.

Meanwhile, a RedCap terminal that satisfies the eMBB scenario other than the mMTC/URLLC scenarios may be required. A terminal equipped with a pressure sensor, humidity sensor, thermometer, motion sensor, accelerometer, and/or the like may be an example of the RedCap terminal. These terminals should be able to be obtained at low cost with low implementation complexity, and the size of the terminals should not be large.

In order to reduce the complexity of the terminal, a bandwidth supported by the terminal may be limited. When operating in a frequency range 1 (FR1), the terminal may operate with a bandwidth of 20 MHz or 40 MHz, and when operating in a FR2, a bandwidth of the terminal may be limited to 100 MHz.

In addition, the number of receiver units (RXUs) that the terminal has may be limited. In general, the minimum number of RxUs that the terminal should have may be determined according to a frequency band in which a mobile communication system operates, but the RedCap terminal may have a smaller number of RxUs than the minimum number of RxUs defined according to the frequency band. For example, in a frequency band in which at least two RxUs should be guaranteed, the RedCap terminal may operate with only one RxU.

The terminal may operate in both a time division duplexing (TDD) mode and a frequency division duplexing (FDD) mode, but may also operate in a half-duplex scheme when operating in the FDD mode. On the other hand, the base station should be able to know whether a terminal is a RedCap terminal or a general terminal. Whether the terminal is a RedCap terminal or a general terminal may be identified by capability signaling that the terminal transmits to the base station.

### Duplex Direction Interpretation Method

The operation scheme of the terminal operating in the mobile communication system may be classified into a full-duplex scheme and a half-duplex scheme. In the full-duplex scheme, the terminal may simultaneously perform transmission and reception in the same time resource. In this case, a frequency band in which the terminal performs transmission and a frequency band in which the terminal performs reception are appropriately separated from each other. An interval between the frequency band in which the terminal performs transmission and the frequency band in which the terminal performs reception may be defined as a duplex gap. In the half-duplex scheme, the terminal may perform only one of transmission and reception in the same time resource.

Due to the advantage of simplifying the implementation of the terminal, when the operation according to the half-duplex scheme is considered, the cost of the terminal may be lowered, and power consumption of the terminal may be reduced. The base station should perform configuration and scheduling for the terminal so that a time resource in which the terminal performs reception and a time resource in which the terminal performs transmission do not overlap with each other. Therefore, the configuration (scheduling) for the terminal should be performed so that the terminal does not perform transmission in a symbol in which the terminal receives a PDSCH, and the configuration (scheduling) for the terminal should be performed so that the terminal does not perform reception in a symbol in which the terminal transmits a PUSCH. This may be implemented naturally in the TDD mode.

For example, a terminal configured with one serving cell (or a bandwidth part (BWP)) may operate according to the half-duplex scheme in the TDD mode. Considering a terminal configured with two or more serving cells (or BWPs), slot patterns of the serving cells (or BWPs) may be different from each other. In this case, according to an indication of the base station, the terminal may operate in the same time resource (e.g., symbol) according to the full-duplex scheme. If the slot patterns of all serving cells (or BWPs) configured to the terminal are always the same, it is sufficient for the terminal to operate in the half-duplex scheme.

The terminal may report to the base station a capability of operating only in the half-duplex scheme. Since the base station identifies that the corresponding terminal cannot operate in the full-duplex scheme, it may instruct the terminal to operate only in the half-duplex scheme through a higher layer message.

Signaling of a certain higher layer message may not be allowed for the terminal depending on the TDD mode and the FDD mode, and an application scheme of the same higher layer message may vary. In the TDD mode, the base station may cause the terminal to operate in the half-duplex scheme by indicating appropriate slot pattern(s) to the terminal. For example, when the base station indicates slot pattern(s) to a terminal in which carrier aggregation (CA) is configured and/or performs scheduling for the terminal, the base station may prevent a DL symbol and a UL symbol for the corresponding terminal from occurring at the same time position.

On the other hand, in the FDD mode, the terminal may generally operate in the full-duplex scheme. Since a DL component carrier (CC) and a UL CC operate as a pair, in order for the terminal to operate in the half-duplex scheme, a temporal gap should be allocated between DL symbol(s) and UL symbol(s) so that the DL symbol(s) and the UL symbol(s) are not arranged consecutively with each other. According to the size of the temporal gap, the half-duplex scheme may be classified into different types. For example, the half-duplex scheme may be classified into a type A and a type B. In the type A half-duplex scheme, the base station may allocate a small number of symbols to the terminal to maintain a gap between the DL symbol(s) and the UL symbol(s). In the type B half-duplex scheme, the base station may allocate one slot (or subframe) to the terminal to maintain a gap between the DL symbol(s) and the UL symbol(s). More specifically, when a DL slot and a UL slot are arranged consecutively, the terminal operating in the type A half-duplex scheme may not receive the last few DL symbol(s) of the DL slot.

### (1) PUSCH Transmission Method

Since the terminal cannot simultaneously perform transmission and reception in the same symbol in the half-duplex scheme, the terminal may assume that a DCI scheduling to generate a symbol in which the terminal simultaneously performs transmission and reception is not received from the base station.

The terminal may not receive a higher layer signaling to generate a symbol in which transmission and reception are performed at the same time. Such higher layer signaling may be higher layer signaling received by the terminal. For example, since the terminal at least performs a reception operation in symbols indicated by configuration of a PDCCH utilized for initial access (e.g., PDCCH received in a type0/0A/1/2-PDCCH CSS set) and symbols indicated through a higher layer signaling (e.g., dedicated signaling) received by the corresponding terminal, the terminal may assume that no transmission is performed in the same symbols.

In the FDD mode, the base station may not indicate a slot pattern to the terminal. This is because an RRC message indicating a slot pattern is defined in the TDD mode. In the FDD mode, all symbols in an active UL BWP may be interpreted as UL symbols, and all symbols in an active DL BWP may be interpreted as DL symbols. When the terminal operating in the half-duplex scheme is allocated a DL signal/channel by a PDCCH received in a configured CORESET/search space, the terminal may regard the corresponding symbols as DL symbols, and when the terminal is allocated a UL signal/channel, the terminal may regard the corresponding symbols as UL symbols.

In a symbol for transmitting a UL signal/channel, the terminal may need to monitor the configured CORESET/search space or receive an SS/PBCH block. In this case, according to an method, the terminal may follow a scheduler. When receiving a DL-DCI, the terminal may not transmit a configured UL signal/channel in a symbol for receiving a DL signal/channel. When receiving a UL-DCI, the terminal may not receive a configured DL signal/channel. This is more concretely expressed as Method A.1-1 below. Method A.1-1 may correspond to a method of identifying a priority for resolving a collision between DL reception and UL transmission from a DCI.

Method A.1-1: The terminal operating in the half-duplex scheme may not transmit (or receive) a configured signal/channel while performing reception (or transmission) of a signal/channel allocated by a DCI.

Here, the configured UL signal/channel may include a PRACH preamble, SRS, PUSCH, and PUCCH, and the configured DL signal/channel may include an SS/PBCH block, PDCCH, tracking reference signal (TRS), and PDSCH. The terminal may transmit a configured UL signal/channel or a UL signal/channel scheduled or activated by a received UL-DCI, and may ignore a PDCCH monitoring occasion while performing the transmission.

When higher layer signaling is received so that the terminal receives a PDCCH, PDSCH, CSI-RS, or DL PRS, the terminal may receive the PDCCH, PDSCH, CSI-RS, or DL PRS in symbol(s) configured to receive the channel or signal. However, a certain DCI may instruct the terminal to transmit a PUSCH, PUCCH, PRACH, or SRS in symbol(s) configured to receive a PDCCH, PDSCH, CSI-RS, or DL PRS. That is, one of the symbol(s) indicated to transmit the PUSCH, PUCCH, PRACH, or SRS may overlap with a symbol configured to receive the PDCCH, PDSCH, CSI-RS, or DL PRS.

If the terminal does not receive the DCI described above, the terminal may receive the PDCCH, PDSCH, CSI-RS, or DL PRS in the symbol(s) configured to receive the PDCCH, PDSCH, CSI-RS, or DL PRS. If the terminal receives the DCI described above, the terminal may not receive the PDCCH, PDSCH, CSI-RS, or DL PRS in the corresponding symbol(s).

When the terminal receives higher layer signaling to transmit an SRS, PUCCH, or PUSCH, the terminal may transmit the SRS, PUCCH, or PUSCH in symbol(s) configured to transmit the channel or signal. However, a certain DCI may instruct the terminal to receive a CSI-RS or PDSCH in the symbol(s) configured to transmit the SRS, PUCCH, or PUSCH. That is, one of the symbol(s) configured to receive the CSI-RS or PDSCH may overlap with a symbol configured to transmit the SRS, PUCCH, or PUSCH.

If the terminal does not receive the DCI described above, the terminal may transmit the SRS, PUCCH, or PUSCH in the symbol(s) configured to transmit the SRS, PUCCH, or PUSCH. If the terminal receives the DCI described above, the terminal may or may not cancel transmission of the SRS, PUCCH, or PUSCH in the symbol(s) configured to receive the CSI-RS or PDSCH in consideration of a processing time to be described later.

For convenience of description, the symbol(s) in which the SRS, PUCCH, or PUSCH is transmitted may be expressed as a symbol set, the first symbol of the symbol set may be expressed as a symbol 1, and the last symbol of a CORESET including the DCI instructing the terminal to receive the CSI-RS or PDSCH may be expressed as a symbol 0.

If the symbol 1 occurs before a predetermined time (e.g., T_{proc,2}) elapses from the symbol 0, the terminal may not cancel transmission of the PUCCH or PUSCH. If the symbol 1 occurs after the predetermined time elapses from the symbol 0, the terminal may cancel transmission of the PUCCH, the PUSCH, or a repeated transmission instance (i.e., actual repetition or split instance) of the PUSCH to be transmitted in the symbol set.

The terminal may not cancel transmission of the SRS in symbols belonging to the symbol set occurring before the predetermined time elapses from the symbol 0. The terminal may cancel transmission of the SRS in SRS symbol(s) belonging to the symbol set occurring after the predetermined time elapses from the symbol 0. The SRS may be transmitted in symbols before the predetermined time elapses in the symbol set, the SRS may not be transmitted in subsequent symbols, and the SRS may be transmitted in symbols belonging to the SRS without belonging to the symbol set.

Here, the predetermined time (e.g., T_{proc,2}) may refer to a time required for the terminal to transmit a PUSCH, and may correspond to a processing capability 1 defined in the technical specification (e.g., TS 38.214). Here, d_{2,1} may be 1, and μ may be a smaller subcarrier spacing (SCS) among an SCS at which the DCI is received and an SCS used in UL transmission (e.g., SRS, PUSCH, and PUCCH). Alternatively, in case of a PRACH, μᵣ may be 1 when the PRACH is transmitted using an SCS of 15 kHz, and μᵣ may be 0 otherwise.

According to another method, the terminal may select one operation (i.e., reception or transmission) by comparing priorities of UL and DL. According to a method below, a slot pattern may be indicated to the terminal operating in the half-duplex scheme.

Method A.1-2: The terminal may receive RRC signaling (or control message) indicating a duplex direction of a symbol from the base station.

While operating in the FDD mode, the terminal may determine whether to receive a DL signal/channel or transmit a UL signal/channel according to a duplex direction of symbols. Scheduling and/or configuration information received by the terminal may not indicate a duplex direction that collides with RRC signaling (or configuration) on a duplex direction.

The terminal may be indicated (or configured) with DL symbol(s), FL symbol(s), or UL symbol(s) through RRC signaling, and may not receive a slot format indicator (i.e., dynamic SFI) from an additional DCI. In this case, the terminal may determine UL transmission or DL reception according to the duplex direction indicated (or configured) through RRC signaling. Also, since a dynamic SFI is not received, an FL symbol may not be changed to a DL symbol or a UL symbol.

The slot format indicated (or configured) to the terminal through RRC signaling may indicate arrangement of DL symbol(s), FL symbol(s), and/or UL symbol(s) for a predetermined slot. In this manner, the slot format for predetermined slots may be repeatedly applied. For example, if a slot format for slots corresponding to 40 ms is indicated (or configured) by RRC signaling, the terminal may repeatedly apply the corresponding slot format every 40 ms.

A resource (i.e., PDSCH, PUSCH, or PUCCH) may be dynamically allocated to the terminal through a scheduling DCI or activating DCI. A type 1 CG PUSCH may be transmitted only in UL symbols indicated (or configured) by RRC signaling.

When the terminal operates in the half-duplex scheme, a temporal gap may be required between DL reception and UL transmission. When operating in the TDD mode, since the active DL BWP and the active UL BWP are configured to have the same center frequency, only a circulator switch delay may be considered as the temporal gap between DL and UL. This is considered as timing alignment in the technical specification. A value considering a circulator switch delay and a timing advance may be indicated as the temporal gap by the base station through a timing advance command. As a temporal gap between a time when the base station performs UL reception and a time when the base station performs DL transmission, a value considering a circulator switch delay may be considered as a timing advance offset. The timing advance offset values for FR1 and FR2 may be different.

When the terminal operates according to the half-duplex scheme in the FDD mode, the active DL BWP and the active UL BWP may have different center frequencies. In this case, a frequency separation may correspond to a duplex gap. Accordingly, an additional time (e.g., BWP switching delay) should be considered as a temporal gap from when the terminal performs DL reception to when the terminal performs UL transmission. For example, when the duplex gap is large, the BWP switching delay may have a larger value because inter-frequency retuning may be required.

The terminal needs to receive a DL signal/channel and transmit a UL signal/channel in consideration of such the time (i.e., circulator switching delay, timing advance, timing advance offset, BWP switching delay, etc.). In this manner, Method A. 1-2 may be applied to the terminal or Method A. 1-3 below may be applied to the terminal.

Method A.1-3: The base station may indicate to the terminal a rate matching resource pattern applicable to a UL signal/channel.

The base station may indicate rate matching resources applicable at least to a PUSCH to the terminal. Time resources and frequency resources of one or more rate matching resources may be determined through RRC signaling, and one rate matching resource among the one or more rate matching resources may be selected by a scheduling DCI. The rate matching resources may be expressed in a bitmap, and one bit in the bitmap may indicate a predetermined time resource and/or a predetermined frequency resource. The bitmap may include information on at least one slot.

As an example, one bit may indicate information about a region for which a symbol is a unit as a time resource and an RB is a unit of a frequency resource. For example, one bit may indicate a symbol of the entire band of the active BWP or the entire band of the UL CC. In this case, the rate matching resource may be regarded as an invalid symbol pattern. A method to be described later may be applied to the invalid symbol pattern to perform symbol-level rate matching.

When the terminal receives the rate matching resource, the terminal may affect RE mapping of coded bits for a PUSCH/PUCCH by reflecting the rate matching resource. Alternatively, the terminal may cancel transmission of all or part of the PUSCH/PUCCH transmission without affecting the RE mapping. In case of SRS, the terminal may not transmit the SRS in symbol(s) overlapping the rate matching resource.

One bitmap may be configured by concatenating a sub-bitmap expressed in units of symbols and a sub-bitmap expressed in units of RBs. The terminal may obtain information of ‘1‘s or ‘0’s from the sub-bitmaps, and may know to which time and frequency region the rate matching is to be applied based on an intersection or Kronecker product of the them.

Information on the rate matching resource may be periodically received. The terminal may receive an RRC layer, MAC layer, and/or physical layer control message (e.g., DCI) indicating (or configuring) a periodicity and an offset (e.g., a slot offset in case of slot-based operation) of the rate matching resource from the base station. The terminal may derive the first slot to which the bitmap of the rate matching resource is applied from the information on the periodicity and offset.

Alternatively, the rate matching resource may indicate a resource of a CORESET. As an example, an index of a CORESET may be indicated. The terminal may consider a frequency resource of the CORESET, a time resource of a search space indicated to the terminal, and a resource corresponding to a CORESET duration as the rate matching resource.

Method A.1-4: In Method A.1-3, the rate matching resource pattern may be given only as a bitmap or as an index of a bitmap or CORESET.

Method A.1-5: In Method A.1-3, whether the rate matching resource pattern is applied may be indicated by a scheduling DCI or activating DCI received by the terminal.

When the resource to which the rate matching resource indicated by a field of the scheduling DCI is applied overlaps with a resource of a PUSCH, the terminal may or may not map coded data to the resource of the PUSCH.

For example, the above-described field may consist of one or more bits. If a bit constituting the field have a certain value, the terminal may not perform rate matching for the PUSCH. If the bit constituting the field have another value, the terminal may perform rate matching for the PUSCH. When the field consists of one bit, the base station may configure one rate matching resource to the terminal, and the terminal may determine whether to map coded data with respect to the rate matching resource.

One or more rate matching resources may be indicated (or configured) to the terminal by RRC signaling. Among the indicated (or configured) rate matching resources, for some rate matching resources, the terminal may always perform rate matching to transmit a PUSCH. On the other hand, for the remaining rate matching resources, the terminal may determine whether to perform rate matching for a PUSCH according to the field of the scheduling DCI received by the terminal and/or a value of a parameter preconfigured for determining whether to perform rate matching.

When using a non-fallback DCI (e.g., format 0_1, format 0_2), the terminal may derive a union of the rate matching resources indicated (or configured) by RRC signaling and the rate matching resources indicated to perform rate matching by a field of the DCI. By reflecting the rate matching resource corresponding to the union, the terminal may perform rate matching for the PUSCH. When using a fallback DCI (e.g., format 0_0), the terminal may perform rate matching for the PUSCH in consideration of only the rate matching resource indicated by RRC signaling.

Method A.1-6: In Method A.1-3, the terminal may be indicated (or configured) by RRC signaling so that the rate matching resource pattern is applied.

The rate matching resource may be indicated to the terminal through RRC signaling. When the indicated rate matching resource and the PUSCH resource overlap, rate matching may be performed on coded data in the PUSCH resource.

In this case, the bitmap indicating the rate matching resource should have appropriate bits so that the terminal does not transmit a PUSCH in a gap required for the terminal in order for the terminal to operate in the half-duplex scheme. That is, symbols corresponding to the gap may be represented by the bitmap.

However, when a CORESET is indicated, it may be preferable that symbols considering a UL-DL switching delay and a DL-UL switching delay are additionally considered. This is expressed in Method A.1-7 below, and the terminal may obtain sufficient information for transmitting a PUSCH only by a scheduling/activating DCI and related RRC signaling.

Method A.1-7: In Method A. 1-4, when the rate matching resource indicates an index of a CORESET, rate matching for the PUSCH may be performed by considering an additional gap before the first symbol of the CORESET and after the last symbol of the CORESET.

Here, the gap (or the number of symbols) applied before the first symbol of the CORESET by the terminal and the gap (or the number of symbols) applied after the last symbol of the CORESET may be different, which are indicated (or configured) by RRC signaling. This asymmetry may occur because a timing advance between the terminal and the base station should be additionally considered in the DU-UL switching delay compared to the UL-DL switching delay.

According to another method, the rate matching resource may be indicated to the terminal only by the bitmap, and the terminal may have to observe a PDCCH by using the CORESET and search space configured to the terminal. In this case, the terminal may not transmit a PUSCH in a time resource of a PDCCH monitoring occasion (or a time resource overlapping with the PDCCH monitoring occasion).

In addition, the terminal may not transmit a PUSCH in all or part of time resources in which an SS/PBCH block is transmitted. The base station may indicate (or configure) time resources for transmitting SS/PBCH block(s) to the terminal by RRC signaling, and the terminal may monitor (or receive) a CORESET associated (or mapped) with the indicated SS/PBCH block(s).

Method A.1-8: The terminal may perform rate matching for a PUSCH in consideration of all time resources in which SS/PBCH block(s) and/or a CORESET/search space associated therewith are transmitted and additional gaps before and after them.

When higher layer signaling for allowing the terminal to transmit a PUSCH (or PUCCH or SRS) is received and presence of SS/PBCH block(s) is known through higher layer signaling, the terminal may not transmit all or part of the PUSCH (or PUCCH or SRS) for which a predetermined gap is not secured.

The length of the gap applied before the SS/PBCH block(s) and the gap applied after the SS/PBCH block(s) may be different from each other. For example, a gap required for reception-transmission switching performed by the terminal may be applied to the gap between the first symbol of the PUSCH (or PUCCH or SRS) and the last symbol of the immediately preceding SS/PBCH block, and a gap required for transmission-reception switching performed by the terminal may be applied to the gap between the last symbol of the PUSCH (or PUCCH or SRS) and the first symbol of the immediately subsequent SS/PBCH block.

Method A. 1-8 may be applied in combination with Method A. 1-3, but Method A. 1-8 alone may be applied regardless of Method A. 1-3.

The number of SS/PBCH blocks indicated (or configured) by RRC signaling to the terminal may be large. In this case, the terminal may not monitor or measure all SS/PBCH blocks. In case of the terminal operating in the half-duplex scheme, if rate matching for a PUSCH is performed for all SS/PBCH blocks, UL resource utilization efficiency may be reduced.

Accordingly, the terminal may map coded data in consideration of only a part of the SS/PBCH block(s). In this case, the terminal may not map coded data only to SS/PBCH block(s) and/or a CORESET/search space associated (mapped) therewith indicated by the bitmap of the rate matching resource.

In order to utilize only some of the SS/PBCH blocks, the base station may know which SS/PBCH block(s) the terminal is associated with (or mapped) by using a resource region (i.e., frequency and/or time) of a PRACH preamble last transmitted by the terminal.

Method A.1-9: The base station may inform the terminal of index(s) of some SS/PBCH block(s) to be included in rate matching for a PUSCH through additional RRC signaling (or configuration).

Alternatively, since the terminal and the base station may know which SS/PBCH block the terminal is associated with (or mapped) through the transmission/reception of the PRACH preamble, the terminal may perform rate matching for a PUSCH only with respect to one SS/PBCH block without using Method A.1-9.

Method A.1-10: The terminal may perform rate matching for a PUSCH with respect to only the SS/PBCH block associated with (or mapped) the most recently transmitted PRACH preamble.

When the terminal operates according to the half-duplex scheme in the FDD mode, resources to be considered in PUSCH transmission may be independent of other terminals. For example, when a specific terminal performs rate matching for a PUSCH, the rate matching may be independent of time resources of CORESETs or search spaces received by other terminals. Accordingly, if a rate matching resource to be considered by a specific terminal is expressed by a bitmap or an index of a CORESET, the rate matching resource may include DL symbol(s) to be received by the terminal and/or a gap before and after the DL symbol(s). Therefore, if the rate matching resource is represented by the bitmap, the bitmap may be interpreted in the active UL BWP of the terminal. Accordingly, an SCS may be determined by an SCI of the active UL BWP even if it is not separately indicated when configuring the rate matching resource.

### Exemplary Embodiment: PUSCH Repetition

In order to extend coverage, the terminal may be configured by the base station with the PUSCH repetition type A or PUSCH repetition type B. A PUSCH occasion may be transmitted in several consecutive slots, and each PUSCH instance constituting the PUSCH occasion may be transmitted in one slot. This PUSCH occasion may be scheduled by a UL-DCI, or may be configured/activated by a configured grant.

The terminal operating in the half-duplex scheme may not transmit a PUSCH instance in order to periodically observe a DL signal/channel. Such DL signal/channel may include SS/PBCH block, CORESET/search space, TRS, and CSI-RS. In order to minimize collisions between DL reception and UL transmission, the number of symbols of a PUSCH instance may be reduced. In this case, if a large size of traffic is generated in the terminal, the terminal may need to be allocated a large number of REs and may need to generate a large size transport block (TB). Although a bandwidth of the PUSCH instance may be increased, this is not preferable in consideration of the aspect of the coverage or the implementation cost of the terminal. Therefore, the number of symbols of the PUSCH instance may not be arbitrarily reduced.

In order to indicate a sufficiently low code rate to the terminal, the number of PUSCH instances may be increased. The base station may determine the number of PUSCH instances according to a latency requirement of traffic. In this case, a PUSCH instance and a DL signal/channel may collide in some symbols.

When a rate matching resource is indicated to the terminal, the terminal may consider the rate matching resource and a scheduling/activating DCI (or RRC signaling) in order to map coded data to the PUSCH occasion.

As an example, the terminal may perform rate matching for the PUSCH occasion only with the indicated rate matching resource. It is considered that the time resource represented by the indicated rate matching resource includes at least an SS/PBCH block pattern and/or a CORESET/search space associated therewith (or mapped).

In another example, the terminal may perform rate matching for the PUSCH occasion by using at least the indicated rate matching resource, the SS/PBCH block pattern, and/or the CORESET/search space associated therewith.

When a rate matching resource is not configured to the terminal, the terminal may perform rate matching for the PUSCH occasion in all or a part of the SS/PBCH block pattern and a predetermined gap before and after the SS/PBCH block pattern. The SS/PBCH block pattern indicated to the terminal may be given by RRC signaling and may be derived from ssb-PositionsInBurst included in an SIB1 or ServingCellConfigCommon. The terminal may regard symbols belonging to the SS/PBCH block as invalid symbols, and may apply this assumption to the rate matching for the PUSCH.

When the PUSCH repetition type A is indicated, the terminal may not transmit coded data in symbols indicated as the rate matching resource or some of them among symbols belonging to a PUSCH instance. In this case, the PUSCH instance may not be transmitted.

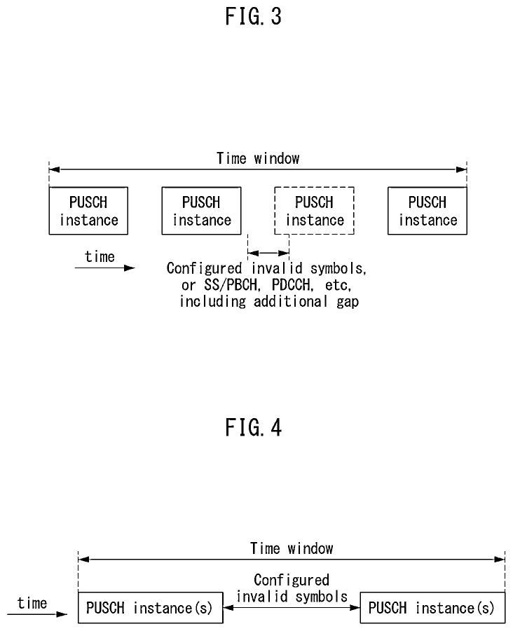

FIG. 3 is a conceptual diagram illustrating an exemplary embodiment of transmitting a PUSCH instance according to a rate matching resource when the PUSCH repetition type A is configured (or indicated).

Referring to FIG. 3, the PUSCH repetition type A may be configured (or indicated) to the terminal, and a length of a time window may be determined based on the number of repeated PUSCH transmissions and the number of symbols each PUSCH instance has. The terminal may know that some PUSCH instances are not transmitted according to indicated rate matching resources, other DL signals/channels (e.g., SS/PBCH block, PDCCH, etc.), or gaps within the time window.

In another example, the length of the time window may be extended to ensure the number of repeated transmissions. The terminal may not transmit some PUSCH instances according to the indicated rate matching resources, other DL signals/channels, or gaps. In this case, the terminal may transmit the corresponding PUSCH instance in the next slot. The length of the time window may be interpreted as being extended until all PUSCH instances according to the configured number of repeated transmissions are transmitted. Although this scheme is a scheme applied to repeated transmission of a PUCCH in the TDD mode, it may also be applied to the terminal operating according to the half-duplex scheme in the FDD mode.

In an exemplary embodiment, the base station may configure the terminal to operate in one of the two schemes described above through RRC signaling. That is, the terminal may cancel transmission of a PUSCH instance in an invalid symbol, and the canceled PUSCH instance transmission may or may not be included in the number of repeated transmissions according to RRC signaling.

When the PUSCH repetition type B is indicated, the terminal may not transmit code data in symbol(s) indicated as invalid symbol(s) or rate matching resource or some of the symbol(s). In this case, it may be transmitted as a split PUSCH instance. That is, another redundancy version (RV) of the data that the terminal intends to transmit may be mapped to the split PUSCH instance. Depending on a combination of the rate matching resource, DL signal/channel, and gap, the methods proposed above may be expressed through various examples.

FIG. 4 is a conceptual diagram illustrating an exemplary embodiment in which rate matching is performed by applying invalid symbol(s) when the PUSCH repetition type B is configured (or indicated).

Referring to FIG. 4, time resources of PUSCH instance(s) may be determined only by the rate matching resource or invalid symbol pattern.

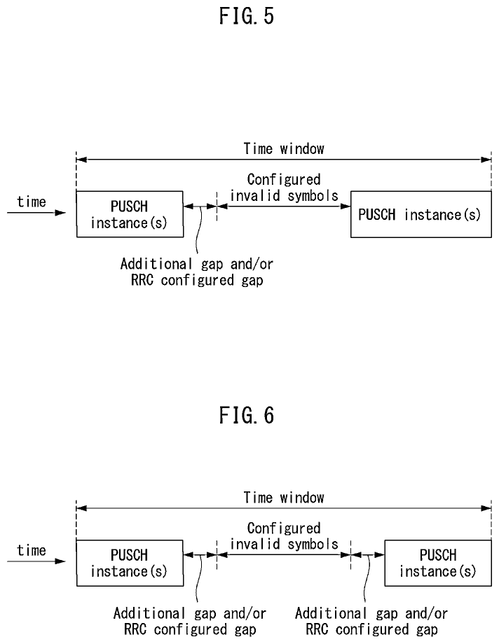

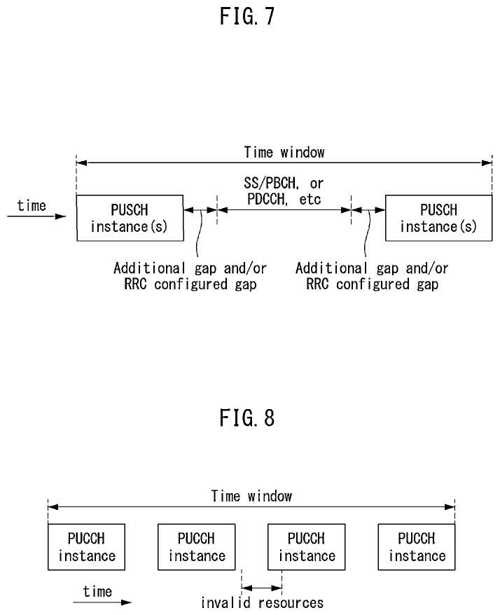

FIG. 5 is a conceptual diagram illustrating an exemplary embodiment in which rate matching is performed by applying invalid symbol(s) and a gap before the invalid symbol(s) when the PUSCH repetition type B is configured (or indicated), FIG. 6 is a conceptual diagram illustrating an exemplary embodiment in which rate matching is performed by applying an invalid symbol pattern and gaps before and after the invalid symbol pattern when the PUSCH repetition type B is configured (or indicated), and FIG. 7 is an exemplary embodiment in which a PUSCH instance is transmitted by applying a DL signal/channel and gaps before and after the DL signal/channel when the PUSCH repetition type B is configured (or indicated).

Referring to FIG. 5, the terminal may determine a time resource of PUSCH instance(s) by applying a gap before the rate matching resource or the invalid symbol(s). Referring to FIG. 6, the terminal may determine a time resource of PUSCH instance(s) by applying additional gaps before and after the rate matching resource or the invalid symbol(s). Referring to FIG. 7, when the rate matching resource or invalid symbol pattern is not separately indicated or activated, the terminal may determine a time resource of PUSCH instance(s) by considering additional gaps before and after a DL signal/channel.

Method A.1-11: invalidSymbolPattern configurable (or indicatable) only in the TDD mode may be configured (or indicated) also in the FDD mode. In addition, invalidSymbolPattern may be applied to the PUSCH repetition type A as well as the PUSCH repetition type B.

When the terminal needs to receive a DL signal/channel in the first symbol of a slot, if the terminal is transmitting a PUSCH instance in consecutive symbols immediately before the first symbol, a predetermined gap may be required considering the operation of the half-duplex scheme. That is, the terminal may map coded data to a split PUSCH instance by additionally considering the predetermined gap. The predetermined gap may be indicated to the terminal by RRC signaling.

The terminal may transmit a PUSCH occasion even after the symbol in which the terminal receives the DL signal/channel. The terminal may apply the predetermined gap from the last symbol of the DL signal/channel, and map the coded data to a split PUSCH instance. The predetermined gap may be indicated (or configured) to the terminal by RRC signaling. The predetermined gap may be configured by the number of symbol(s).

### (2) PUCCH Transmission Method

Spread UCI or coded UCI may be mapped to a PUCCH. Rate matching for a PUCCH may not be performed, and the entire spread UCI or coded UCI may be transmitted. In case of PUCCH repetition, PUCCH instances to which the same spread UCI or coded UCI is mapped may be transmitted at a constant interval (e.g., a slot or a subslot).

In a system operating in the FDD mode, the terminal may transmit all PUCCH instances at a predetermined interval in order to transmit a PUCCH occasion. In a system operating in the TDD mode, since some symbol(s) belonging to a PUCCH occasion may be DL or FL symbol(s), the terminal may not transmit some PUCCH instances in the corresponding time resources (i.e., DL or FL symbol(s)). Instead, the terminal may transmit a PUCCH instance that has not been transmitted in a subsequent time resource by extending a time window for transmitting the PUCCH occasion to guarantee the number of PUCCH instances. That is, in the FDD mode, the time window of the PUCCH occasion may be determined only by the number of repeated transmissions, and in the TDD mode, the time window of the PUCCH occasion may be determined by using additional information such as the number of repeated transmissions and a slot pattern.

In a system operating in the FDD mode, when the terminal operates in the half-duplex scheme, the terminal may not transmit some PUCCH instances belonging to a PUCCH occasion. This may be due to a rate matching resource, invalid symbol pattern, DL signal/channel in which a PUSCH instance cannot be transmitted and/or a gap that is further considered. For convenience of description, the invalid resource may refer to the rate matching resource, invalid symbol pattern, DL signal/channel, and/or gap that is further considered. The invalid resource may be configured for a PUSCH occasion, which may also be applied to a PUCCH occasion. Alternatively, the invalid resource may be applied to an arbitrary UL signal/channel as well as the PUSCH occasion or PUCCH occasion.

Method A.2-1: A terminal operating in the half-duplex scheme may derive an invalid resource based on information indicated (or configured) from the base station, and the derived invalid resource may be applied to all UL signals/channels.

Accordingly, the PUCCH instance may have a time window determined only by the number of repetitions as in the FDD mode, or may have a time window determined by the number of repetitions and additional information as in the TDD mode.

Method A.2-2: The terminal operating in the half-duplex scheme may transmit a PUCCH occasion in a time window determined only by the number of repetitions.

In the subsequent operations, the terminal may perform the following more subdivided methods.

Method A.2-3: In Method A.2-2, the terminal may assume that the PUCCH instance is not canceled.

A time resource of a PUCCH instance indicated by the base station may not always collide with an invalid resource indicated to the terminal. In this case, the terminal may transmit the PUCCH occasion by applying the indicated number of repetitions. Method A.2-3 may be interpreted as that the operation performed by the terminal operating according to the half-duplex scheme in the system operating in the FDD mode is extended to the case of operating in the half-duplex scheme.

Method A.2-4: In Method A.2-2, a time resource of a PUCCH instance indicated by the base station may partially collide with an invalid resource indicated (or configured) to the terminal. In this case, the terminal may transmit the PUCCH instance.

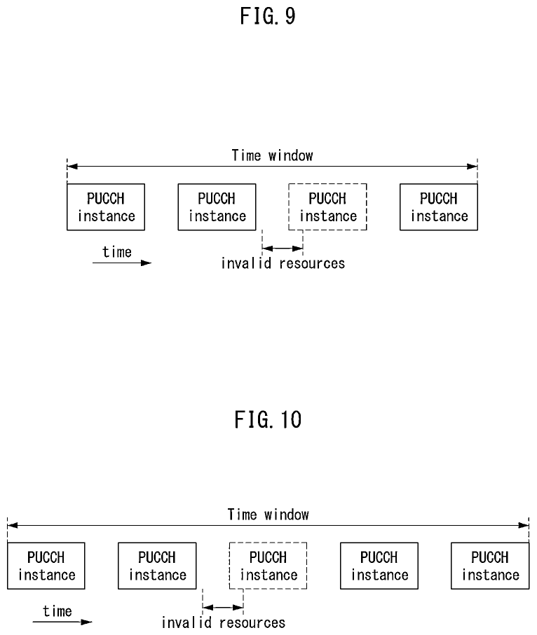

FIG. 8 is a conceptual diagram illustrating an exemplary embodiment of reflecting an invalid resource to a PUCCH occasion, and FIG. 9 is a conceptual diagram illustrating an exemplary embodiment in which an invalid resource is not reflected to a time window of a PUCCH occasion and the invalid resource is reflected to transmission of a PUCCH instance.

Referring to FIG. 8, the time resource of the invalid resource may include a DL signal/channel indicated to the terminal, and in this case, the terminal may not receive the DL signal/channel. Alternatively, referring to FIG. 9, as in Method A.2-5 below, the terminal may receive a DL signal/channel without transmitting a PUCCH instance.

Method A.2-5: In Method A.2-2, the time resource of the PUCCH instance indicated by the base station may partially collide with the invalid resource indicated to the terminal, and in this case, the terminal may not transmit the PUCCH instance.

Here, according to Method A.2-4 and Method A.2-5, an invalid resource may be indicated to the terminal, and may or may not be reflected when transmitting the PUCCH occasion. In Method A.2-4, the invalid resource may be applied to the PUSCH occasion, but not to the PUCCH occasion. In Method A.2-4, the invalid resource may be applied to the PUSCH occasion and the PUCCH occasion.

On the other hand, according to Method A.2-2, since the time resource indicated to the terminal is determined only by the number of repeated transmissions, even if the PUCCH instance is canceled, the terminal cannot transmit the canceled PUCCH instance later. This leads to narrowing the coverage of the PUCCH occasion. To solve this problem, methods of guaranteeing the number of repeated transmissions may be applied even in case of the system operating in the FDD mode. In Method A.2-6 and Method A.2-7 below, these methods are further specified.

Method A.2-6: The terminal operating in the half-duplex scheme may transmit a PUCCH occasion in a time window determined by the number of repeated transmissions and an invalid resource.

Method A.2-7: In Method A.2-6, the time resource of the PUCCH instance indicated by the base station may partially collide with the invalid resource indicated to the terminal. In this case, the terminal may not transmit the PUCCH instance.

FIG. 10 is a conceptual diagram illustrating an exemplary embodiment in which an invalid resource is reflected to a time window of a PUCCH occasion and transmission of a PUCCH instance.

Referring to FIG. 10, since a PUCCH instance not transmitted by the terminal is not included in the number of repeated transmissions, the PUCCH instance not transmitted may be transmitted later. The time interval between PUCCH instances is not changed.

### (3) In Case of Multiple Serving Cells

The rate matching resource may be configured to the terminal for each active UL BWP. When carrier aggregation is configured/activated for the terminal operating in the half-duplex scheme, the rate matching resource may be indicated for each activated serving cell. When multiple CCs are activated for the terminal, the SS/PBCH block pattern and/or rate matching resource may be different for each activated serving cell. In this case, in order for the terminal to determine a time resource of a PUSCH occasion and perform rate matching, the terminal may need information on all activated serving cells.

Method A.3-1: The terminal may perform rate matching on coded data for a PUSCH occasion by using a union of SS/PBCH block patterns.

### Single TB Mapping Over Multiple Slots

When the capability of the terminal is limited, a DL coverage and a UL coverage may also be reduced. The base station may transmit a PDSCH and receive a PUSCH by lowering a code rate in order to widen the coverage. A desired code rate may be achieved by a combination of the method of applying a low MCS and the repeated transmission scheme. In addition, since an MCS table composed of low MCSs cannot be supported depending on the capability of the terminal, the repeated transmission scheme may be considered.

Since an MCS is a nominal code rate, in order to determine an effective code rate, a function of the amount of information (i.e., TB size) that the terminal intends to transmit or receive and the number of REs utilized by a PDSCH/PUSCH should be considered.

According to the technical specification, the size of the TB (i.e., TB size) may be determined as a function of the number of scheduled REs and other parameters. To determine the TB size, the number N_{RE} of REs may be derived, and a parameter N_{info} may be derived from N_{RE}. When the size of N_{info} is smaller than a threshold, the TB size may be determined as a value closest to N_{info} in a TBS table. When the size of N_{info} is greater than the threshold, the TB size may be determined as a value calculated with N_{info}.

Here, N_{RE} is derived by subtracting the number of REs to which data cannot be mapped from the number of REs indicated by the base station. Accordingly, N_{RE} may include both REs that cannot be actually used and a virtual overhead. In addition, the number of REs indicated by the base station is limited within a slot.

In order to further widen the coverage, a further lower code rate may be considered. In case of a TB scheduled by a DCI having a CRC scrambled with P-RNTI, RA-RNTI, or MsgB-RNTI, a scaling factor may be additionally considered. Since a scaling factor having a value smaller than 1 is allowed, the TB size may be determined by applying a smaller (or larger) N_{info} to which the scaling factor is applied. Here, the case of applying N_{info} increased by applying the scaling factor may be the case of determining the TB size from the number of REs obtained from one or more slot(s).

The coverage may be considered in both DL and UL. For example, considering the case where the number of R×Ps is small according to the capability of the terminal, or a CC of a high frequency band (e.g., 60 GHz band) in which a transmission power of the base station is not large, the DL coverage may be considered. For example, when a power that can be allocated by the terminal is limited, the UL coverage may be considered.

For convenience of description, methods presented below are described by taking an example of a PDSCH, but may be equally applied to a PUSCH.

### (1) TB Size Scaling

The number of REs allocated to a PDSCH or PUSH may be related to the amount of energy that the base station or the terminal can allocate (i.e., ‘energy per RE (EPRE)’) and/or the accuracy of channel estimation performed by the terminal or the base station. In order to improve the accuracy of channel estimation, it is necessary to schedule a large number of REs for the PDSCH/PUSCH, but it may be preferable that the PDSCH/PUSCH do not have a large TB. To this end, one TB may be mapped to two or more slots.

In order for the terminal to receive a PDSCH, a time domain resource assignment (TDRA) and a frequency domain resource assignment (FDRA) may be indicated (or configured) to the terminal. In this case, the TDRA may consist of two or more SLIVs. When deriving the TB size, all SLIVs indicated by the TDRA may be considered to derive N_{RE}. However, since this may mean a TB that is too large, the TB size may be reduced by considering a scaling factor.

Method B.1-1: A TB size scaling factor may also be applied to a TB scheduled by a PDCCH scrambled with a C-/MCS-C/CS-RNTI.

The terminal may assume that the TB size scaling factor is given as a value of a field included in a scheduling DCI for a TB scheduled using a C-/MCS-C-RNTI. In addition, in case of a type 1 CG PUSCH, the terminal may assume that the TB size scaling factor is indicated (or configured) by RRC signaling. Also, in case of a type 2 CG PUSCH, the terminal may assume that the TB size scaling factor is given as a value of a field included in an activating DCI.

Meanwhile, since an aspect that the TB size scaling is utilized to widen the PDSCH/PUSCH coverage should be considered, the TB size scaling factor may be signaled together with information on whether joint channel estimation over multiple slots is performed. The ‘joint channel estimation over multiple slots’ may refer to a transmission/reception operation of the terminal when one or more TBs are transmitted/received in one or more (mini-) slot(s).

For example, when the terminal needs to receive one or more PDSCH(s) in one or more (mini-) slot(s) and PDSCH DM-RSs belong to different (mini-) slot(s), in general, although the terminal utilizes the corresponding DM-RSs for quasi-colocation, the terminal may not utilize the corresponding DM-RSs for channel estimation. However, the terminal instructed to perform the joint channel estimation may utilize PDSCH-DMRSs belonging to different (mini-) slot(s) for channel estimation. According to an implementation, the terminal may store PDSCH DM-RSs received from the base station in a storage device, complete joint channel estimation over several (mini-) slot(s), and then perform TB decoding.

For example, when the terminal needs to transmit one or more PUSCH(s) in one or more (mini-) slot(s) and PUSCH DM-RSs belongs to different (mini-) slot(s), in general, although the terminal utilizes the corresponding DM-RSs for quasi-colocation, the terminal may not utilize the corresponding DM-RSs for channel estimation. However, the terminal instructed to perform the joint channel estimation may need to transmit PUSCH(s) so that a power coherence and/or phase coherence is satisfied in order for the terminal to utilize the PUSCH DM-RSs belonging to different (mini-) slots for the channel estimation.

Method B.1-2: When the terminal is instructed (or configured) to perform joint channel estimation, a TB size scaling factor may be derived.

The terminal may be instructed (or configured) through RRC signaling to perform joint channel estimation. Alternatively, the base station may indicate (or configure) a certain field to be added to a scheduling/activating DCI by RRC signaling. In this case, in the scheduling/activating DCI, a combination of joint channel estimation and TB channel estimation may be indicated to the terminal. That is, a certain field of the DCI may be used to derive both whether the joint channel estimation is performed and the TB scaling factor by using an index.

For example, the certain field of the DCI may consist of 2 bits. The field consisting of 2 bits may indicate one of an index indicating not to perform both joint channel estimation and TB scaling, and index(es) indicating that both joint channel estimation and TB scaling are performed and a TB scaling factor to be applied.

Table 1 relates to an example in which joint channel estimation and TB scaling factor are indicated as being combined.

TABLE 1

| DCI | Joint channel | TB scaling |
|---|---|---|
| field | estimation | factor |
| 00 | Disable | 1.0 |
| 01 | Enable | a |
| 10 | Enable | b |
| 11 | Enable | c |

Referring to Table 1, both whether to perform joint channel estimation and a TB scaling factor to be applied may be derived using one code point (or index) indicated by the 2-bit field. Here, values of a, b, and c may be values defined by the technical specification or indicated (or configured) by RRC signaling to the terminal. Each of the values of a, b and c may be less than 1 and greater than 0.

In another example, the values of a, b, and c may be greater than 1. In order to obtain a TB of a larger size, the terminal may apply the TB scaling factor to the number of REs limited within one slot. This is because the corresponding TB can be transmitted in two or more slots.

By resource allocation for a PDSCH/PUSCH, one TB may be transmitted over several slots, but a small number L of symbols may be allocated to one slot. In this case, the TB scaling factor may be indicated as a number greater than 1. The reason is that one TB (or one RV) may be mapped using REs available in two or more slots.

As another example, a candidate value of the TB scaling factor and whether or not joint channel estimation is performed may form an ordered pair, and these ordered pairs may be delivered as a list to the terminal through RRC signaling. A field of a scheduling/activating DCI may indicate to the terminal an index indicating one ordered pair belonging to the list.

### (2) Code Block Mapping Over Two Data Instances

For convenience of description, it is assumed that one PDSCH/PUSCH instance constituting a PDSCH/PUSCH occasion is configured with an SLIV and a FDRA.

The terminal may map coded data having the same RV to two or more PDSCH/PUSCH instances. That is, according to the conventional method, the terminal may repeatedly receive a TB according to a TDRA index implying only one SLIV. In this case, the TB is received at the same position indicated by the SLIV in each slot, and the RVs may always be the same or may have a predetermined order (e.g., (0, 0, 0, 0 . . . ), (0, 2, 3, 1, 0, . . . ), or (0, 2, 0, 2, . . . )).

However, according to a proposed method, one RV may be sequentially mapped. That is, two or more SLIVs may be combined to map coded data as if it were one resource. The last RE according to one SLIV and the first RE according to another SLIV may be derived from consecutive coded data stored in a circular buffer. Accordingly, C (or C_{UL-SCH}) code blocks constituting the TB may belong to two or more (mini-) slots or two or more PDSCH/PUSCH instances.

Method B.2-1: One code block may belong to only one (mini-) slot or one PDSCH/PUSCH instance.

When some REs are left among REs belonging to a PDSCH/PUSCH instance, modulation symbols corresponding to one code block may not be mapped. In this case, one code block may be divided and mapped to two PDSCH/PUSCH instances. To prevent this, code block segmentation may be performed for the code block to prevent such REs from occurring, or dummy bits may be included in the code block.

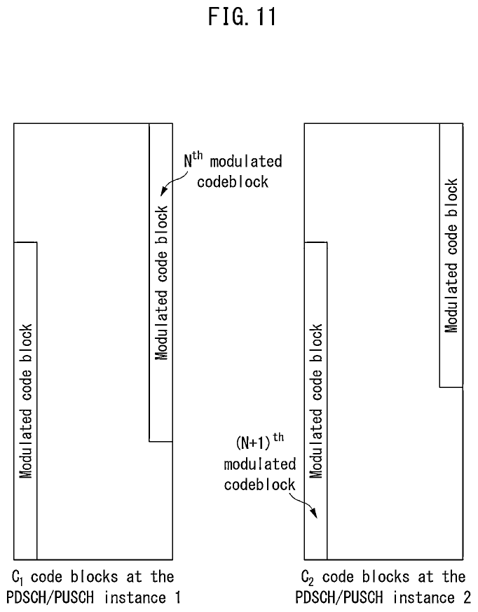

FIG. 11 is a conceptual diagram illustrating an exemplary embodiment in which a modulated code block belongs to only one PDSCH/PUSCH instance.

For example, when one TB is transmitted in two PDSCH/PUSCH instances, the terminal may map C code blocks to two PDSCH/PUSCH instances. Referring to FIG. 11, C₁ code blocks may be mapped to a PDSCH/PUSCH instance 1, and the remaining code blocks (i.e., (C₂=C_{UL-SCH}-C₁) code blocks) may be mapped to a PDSCH/PUSCH instance 2. The above-described mapping may correspond to RE mapping performed by the terminal when Method B.2-1 is used. Bit selection (from the circular buffer) may be performed so that a boundary at which the modulated code block is mapped to REs and a boundary of the PDSCH/PUSCH instance are aligned.

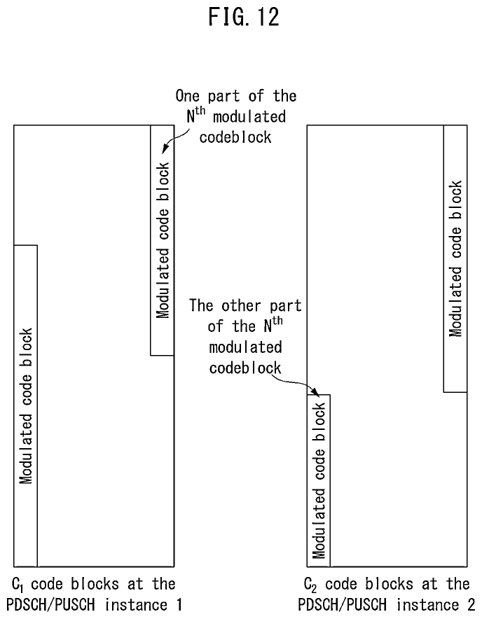

FIG. 12 is a conceptual diagram illustrating an exemplary embodiment in which a modulated code block belongs to two PDSCH/PUSCH instances.

On the other hand, if one code block is mapped to two PDSCH/PUSCH instances, as shown in FIG. 12, the N-th code block may be divided into two segments and mapped to different PDSCH/PUSCH instances.

If one TB consists of only one code block (C=1), the code block mapped to the PDSCH/PUSH instance 1 and the code block mapped to the PDSCH/PUSCH instance 2 may the same.

In a method, the coded bits of the code block may be mapped to the PDSCH/PUSH instance 1 and then mapped to the PDSCH/PUSCH instance 2. Thereafter, interleaving may be performed for the coded bits, and the interleaving may be performed only on coded bits belonging to the same PDSCH/PUSH instance. This may be extended to the case of coded bits mapped to PDSCH/PUSH instance(s) belonging to the same slot.

To describe this case in more detail, instances belonging to the PDSCH/PUSCH occasion may be classified into two types according to mapped RVs. Although the same RV is mapped to some PDSCH/PUSCH instances, they may be transmitted in different (mini-) slot(s). The coded bits may be mapped to these PDSCH/PUSCH instances at consecutive positions.

That is, the coded bits corresponding to an index of one RV may be transmitted in several PDSCH/PUSCH instances. For the PDSCH/PUSCH instance 2 following the PDSCH/PUSCH instance 1 for which the coded bits are determined from the RV index, coded bits consecutive to the coded bits mapped to the PDSCH/PUSCH instance 1 may be mapped. When UCI is mapped to the PDSCH/PUSCH instance 1, a start position of coded bits mapped to the PDSCH/PUSCH instance 2 may be changed by the UCI. Also, when the RV is changed, these PDSCH/PUSCH instances use the same procedure again, but the coded bits may be mapped to the PDSCH/PUSCH instances using the changed RV.

In another method, a start of the coded bits of the code block may be determined with a different RV. Therefore, the coded bits determined by RV a may be mapped to the PDSCH/PUSH instance 1, and the coded bits determined by RV b may be mapped to the PDSCH/PUSH instance 2. Similarly, interleaving may be performed only on coded bits belonging to the same PDSCH/PUSH instance. This may be extended to the case of coded bits mapped to PDSCH/PUSH instance(s) belonging to the same slot.

UCI and data may be multiplexed in a PUSCH instance. In this case, the UCI and the data may undergo different encoding procedures, and different codewords may be derived from the UCI and the data. The different codewords may be mapped to different modulation symbols.

### (3) Time Domain Resource Allocation

The terminal may receive a TDRA list (or TDRA table) from the base station through RRC signaling. Alternatively, the TDRA list (or TDRA table) may be predefined by the technical specification. The base station may indicate a TDRA index for the TDRA list (or TDRA table) to the terminal through a DCI or RRC signaling.

The base station may indicate (or configure) an SLIV to the terminal, or may independently indicate (or configure) S and L to the terminal. Here, the SLIV means an index combining S and L, and S and L may be uniquely derived from the SLIV (one-to-one correspondence).

In order for one TB to be mapped to two or more (mini-) slot(s), PDSCH/PUSCH instances may be arranged at a constant interval (e.g., (mini-) slot) or may be arranged consecutively.

The position of the first symbol to which the PDSCH/PUSCH is allocated may be represented by S, and a position of the last symbol to which the PDSCH/PUSCH is allocated may be represented by S+L. Here, the value of L may be allowed to be 14 or more, and the value of S+L may be more than 14. As an example, the value of S+L may exceed 28. As an example, the PDSCH/PUSCH may be allocated to two or more slots (e.g., three slots).

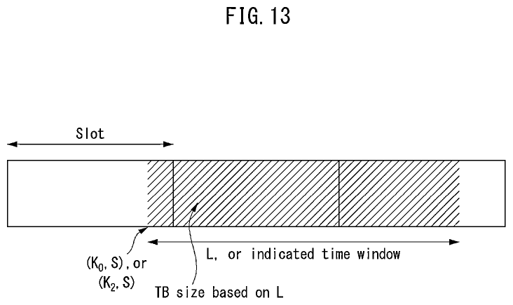

FIG. 13 is a conceptual diagram illustrating an exemplary embodiment in which a PDSCH/PUSCH is allocated to cross a boundary of a slot.

Referring to FIG. 13, the start symbol of a PDSCH may be derived from (K₀, S), and the start symbol of a PUSCH may be derived from (K₂, S). When subcarrier spacings of a scheduling cell performing cross-carrier scheduling and a scheduled cell are different from each other, a slot offset may be additionally considered. In this case, the allocated PDSCH/PUSCH may have consecutive symbols and may be received/transmitted in one or more (mini-) slots.

In order to determine a TB size, the number of REs allocated to the PDSCH/PUSCH is used as an important factor. In this case, the number of REs may be derived by applying L.

The PDSCH/PUSCH mapping type may be classified into a type A and a type B. The terminal may apply a mapping type indicated (or configured) by a scheduling/activating DCI or RRC signaling. The terminal may be indicated (or configured) only one mapping type. According to the exemplary embodiment of FIG. 13, the PDSCH/PUSCH is received/transmitted in three (mini-) slots. If an independent PDSCH/PUSCH instance is interpreted for each (mini-) slot, a PDSCH/PUSCH occasion received/transmitted by the terminal may include three instances. The mapping type indicated to the terminal may be equally applied to all PDSCH/PUSCH instances.

When the first instance of the PDSCH/PUSCH occasion includes the first symbol of the (mini-) slot, it is preferable to apply the mapping type A. When the PDSCH/PUSCH instance consists only of the ending symbols of the (mini-) slots and does not include the first symbols, it is preferable to apply the mapping type B. Alternatively, the mapping type B may always be indicated to the terminal.

The position and configuration of symbol(s) to which a DM-RS is mapped (e.g., configuration 1 or configuration 2 and/or one symbol or two symbols) may be repeated for each (mini-) slot.

Coded bits according to different RVs may be mapped to different PDSCH/PUSCH instances. For example, in the exemplary embodiment of FIG. 13, since three instances exist, the terminal may map different RVs to the instances. That is, the first RV of an RV sequence indicated to the terminal may be applied to the first instance, the second RV may be applied to the second instance, and the third RV may be applied to the third instance.

### (4) Frequency Domain Resource Allocation

Frequency hopping for a PDSCH may not be defined, but frequency hopping for a PUSCH may be indicated (or configured). The frequency hopping for a PUSCH may be indicated (or configured) by RRC signaling, and may be activated/deactivated by a DCI.

If frequency hopping is performed while transmitting a PUSCH, the frequency hopping may vary according to a PUSCH repetition type (i.e., PUSCH repetition type A or PUSCH repetition type B).

A frequency hopping when a PUSCH is not repeatedly transmitted or when PUSCH instances are repeatedly transmitted while maintaining a predetermined interval (e.g., (mini-) slot) may be defined as a frequency hopping when the PUSCH repetition type A is used. A frequency hopping when PUSCH instances are sequentially arranged while repeatedly transmitting a PUSCH may be defined as a frequency hopping when the PUSCH repetition type B is used.

In the case of PUSCH repetition type A, the frequency hopping may not be applied, or intra-repetition frequency hopping or inter-slot frequency hopping may be applied. When the intra-repetition frequency hopping is performed, a half (e.g., floor (L/2)) of symbols (e.g., L symbols) of the PUSCH may be transmitted as a hop 1 and the other half (e.g., ceil (L/2)) of the symbols of the PUSCH may be transmitted as a hop2. Such frequency hopping may be repeatedly applied for each slot. When the inter-slot frequency hopping is performed, frequency hopping may not be performed within one PUSCH instance, and PUSCH instances may be transmitted using different frequency resources in different slots.

In the case of PUSCH repetition type B, the frequency hopping may not be applied, or inter-repetition frequency hopping or inter-slot frequency hopping may be applied. When the inter-repetition frequency hopping is performed, PUSCH instances may be transmitted in different frequency resources. When the inter-slot frequency hopping is performed, frequency hopping may not be performed for PUSCH instance(s) belonging to the same slot, and the PUSCH instance(s) may be transmitted using different frequency resources in different slots.

The above-described frequency hopping may be applied when different RVs of one TB are mapped to the PUSCH instances. If one TB is mapped to two or more PUSCH instance(s) or two or more (mini-) slots, a boundary at which the frequency hopping is performed for the PUSCH may need to be defined again.

Method B.4-1: When two or more slots are required for the terminal to transmit a PUSCH occasion, boundaries of the slots may be regarded as boundaries of split PUSCH instances.

Some of the symbols for transmitting the PUSCH occasion may include invalid symbols in which the PUSCH cannot be transmitted. The terminal may need to configure a PUSCH instance only with valid symbols except for the invalid symbols.

In the TDD system, the terminal may be indicated (or configured) by RRC signaling so that invalid symbols become DL symbols or FL symbols. Alternatively, invalid symbols may be indicated to the terminal using a slot format indicator of a DCI. The symbols in which SS/PBCH block(s) are received, the symbols in which a type0-PDCCH CSS set is received, or some symbols contiguous with DL symbol(s) among FL symbols may indicated (or configured) to the terminal as invalid symbols. The base station may indicate (or configure) time patterns of the invalid symbols to the terminal through RRC signaling, and may additionally indicate a specific time pattern of the invalid symbols by using a scheduling/activating DCI.

The terminal may regard boundaries of slots or boundaries between invalid symbols and valid symbols as boundaries of split PUSCH instances.

If a length of a split PUSCH instance is given as L′ (≤14), a hop 1 may include a half (e.g., floor (L′/2)) of symbols and a hop 2 may include the remaining symbols (e.g., ceil (L′/2)).

### (5) UCI Piggyback

When the terminal receives a PDSCH occasion, one TB may be received in two or more slots. In this case, the position of the first symbol of the first PDSCH instance may be derived from K₀ and an SLIV (or S). If necessary, a slot offset may additionally be used. A PUCCH including a HARQ-ACK bit may be determined by applying a (sub) slot offset corresponding to K₁ to a (sub) slot to which the last symbol of the last PDSCH instance belongs.

When the (sub) slot in which the PUCCH is transmitted and the (mini-) slot in which the PUSCH occasion or PUSCH instance is transmitted overlap in time, the terminal may perform a procedure of multiplexing UCI in a PUSCH.

Additionally, when the terminal transmits one TB in two or more (mini-) slot(s), in order to multiplex the UCI in the PUSCH, whether the UCI (e.g., HARQ-ACK or CSI) is multiplexed in a PUSCH instance or in a PUSCH occasion has to be decided. Alternatively, the UCI may not be multiplexed in a PUSCH instance, and the UCI may be transmitted on a PUCCH.

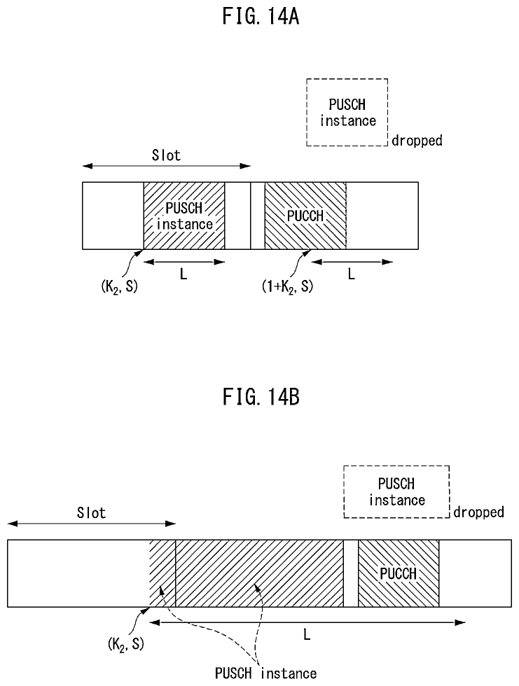

FIGS. 14A and 14B are conceptual diagrams illustrating an exemplary embodiment in which a PUSCH instance is dropped and a PUCCH is transmitted.

Referring to FIGS. 14A and 14B, a PUSCH occasion may be transmitted in two slots to transmit a TB. The terminal may consider a case in which a PUSCH instance for which two SLIVs are applied to consecutive slots and a PUCCH overlap each other in time. In this case, in a slot 1+K₂, the PUCCH and the PUSCH instance may overlap. In an exemplary embodiment, when the PUCCH and the PUSCH instance overlap, the PUCCH may be transmitted. UCI may be transmitted on the PUCCH without being multiplexed in the PUSCH. That is, the PUSCH instance may be dropped.

The above-described example may occur when UCI is repeatedly transmitted. This is because, according to the existing technical specification, when a TB is repeatedly transmitted and UCI is repeatedly transmitted, the UCI may not be multiplexed in a PUSCH. In an exemplary embodiment, the PUCCH may be one PUCCH instance among PUCCH instances repeatedly transmitted in a PUCCH occasion, and in this case, the PUSCH instance may be dropped.

In another example, in a PUSCH occasion in which a TB is mapped to two or more (mini-) slot(s), the UCI may not be multiplexed in a PUSCH instance. This is because, as will be described later, rate matching to be applied to the UCI is not well defined for two or more (mini-) slot(s), but should be defined in a new manner. If the existing technical specification is to be followed as it is, the rate matching for the UCI is not changed, but the terminal should be standardized to conform to Method B.5-1.

Method B.5-1: In case of a TB included in two or more (mini-) slots, UCI may be transmitted on a PUCCH without being multiplexed.

For the case where UCI is allowed to be multiplexed in a PUSCH instance, specific examples may exist. As an example, the UCI may be multiplexed in a PUSCH instance. As another example, the UCI may be multiplexed in a PUSCH occasion.

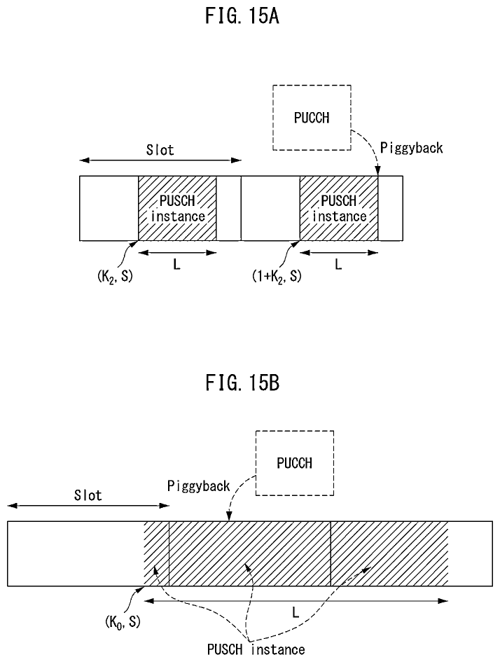

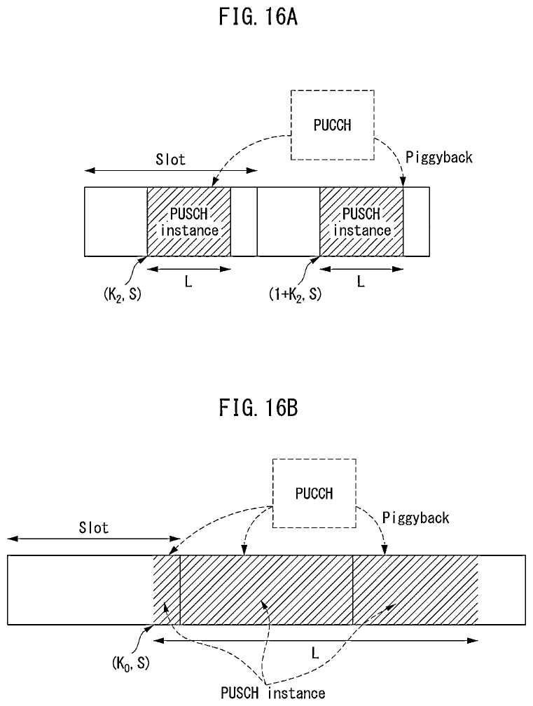

FIGS. 15A and 15B are conceptual diagrams illustrating an exemplary embodiment (‘per PUSCH instance’) in which UCI is multiplexed in a PUSCH instance overlapping a PUCCH, and FIGS. 16A and 16B are conceptual diagram illustrating another exemplary embodiment (‘per PUSCH occasion’ or ‘per TBOMS’) in which UCI is multiplexed in a PUSCH instance overlapping a PUCCH.

Referring to FIGS. 15A and 15B, UCI may be multiplexed only in a PUSCH instance that temporally overlaps with a PUCCH. Referring to FIGS. 16A and 16B, UCI may be multiplexed in all PUSCH instances to which a corresponding TB is mapped, as well as a PUSCH instance temporally overlapping with a PUCCH.

When UCI is multiplexed in a PUSCH, there may be a precedence relationship between a time at which the terminal receives a UL-DCI and a time at which the terminal receives a DL-DCI. The terminal may receive a DL-DCI first and receive a UL-DCI later. In addition, with respect to a PDSCH allocated by the DL-DCI, a sufficient time for decoding a TB and deriving a HARQ-ACK needs to be guaranteed. When all of these conditions are satisfied, the UCI or HARQ-ACK may be spread/coded and multiplexed in a PUSCH. Accordingly, there may be no difference in terms of processing time between the exemplary embodiment of FIG. 13 and the exemplary embodiment of FIG. 14.

The difference between the exemplary embodiment of FIGS. 15A and 15B and the exemplary embodiment of FIGS. 16A and 16B may be determined in rate matching performed when the UCI is spread or encoded. According to the exemplary embodiment of FIGS. 15A and 15B, the UCI may be multiplexed only in a PUSCH instance belonging to one (mini-) slot. According to the exemplary embodiment of FIGS. 16A and 16, the UCI may be multiplexed in all (mini-) slots.

The terminal may be instructed to apply intra-slot frequency hopping to the PUSCH instance. According to the exemplary embodiment of FIGS. 15A and 15B, the UCI may be multiplexed in two frequency hops, but according to the exemplary embodiment of FIGS. 16A and 16B, the UCI may be multiplexed in four frequency hops. According to the existing technical specification, the UCI may be rate-matched only for two or less frequency hops.

When the terminal is instructed to apply inter-slot frequency hopping to the PUSCH instance, the existing technical specification may be applied because the UCI is rate-matched only for two or less frequency hops. However, if one TB is mapped to three (mini-) slots, the existing technical specification for rate matching needs to be modified.

Method B.5-2: In case of a TB included in two or more (mini-) slots, UCI may be multiplexed in only one PUSCH instance.

Method B.5-2 is exemplified in FIGS. 15A and 15B, and may be further subdivided into Method B.5-3 and Method B.5-4 below. A split PUSCH instance may indicate each part when the terminal transmits only a part of a PUSCH instance or when one PUSCH instance is transmitted separately as two or more PUSCH instances.

Method B.5-3: In Method B.5-2, the PUSCH instance may be the first (split) PUSCH instance temporally overlapping with the PUCCH.

The terminal may multiplex the UCI in the earliest PUSCH instance among PUSCH instances overlapping the PUCCH. The corresponding PUSCH instance may be a split PUSCH instance.

Method B.5-4: In Method B.5-2, the PUSCH instance may be the first (split) PUSCH instance belonging to the PUSCH occasion.

If it is determined that the PUCCH and the PUSCH occasion overlap in time, the terminal may multiplex the UCI in the earliest PUSCH instance. The corresponding PUSCH instance may not temporally overlap with the PUCCH, and may be a split PUSCH instance.

According to Method B.5-4 described above, one PUSCH instance in which all PUCCHs overlapping the PUSCH occasion are multiplexed may be determined. For example, if one PUSCH occasion temporally overlaps with several PUCCHs in several slots, the terminal needs to multiplex all UCIs to the first (split) PUSCH instance. In this case, Method B.5-4 may be further subdivided into Method B.5-5 and Method B.5-6.

Method B.5-5: In Method B.5-4, the amount of UCI and/or UCI type that can be multiplexed in the PUSCH occasion may be limited. Up to one HARQ codebook and/or one aperiodic/periodic CSI report may be multiplexed in the first (split) PUSCH instance.

Method B.5-6: In Method B.5-4, the amount of UCI and/or UCI type that can be multiplexed in the PUSCH occasion may not be limited. HARQ codebooks may be concatenated or aperiodic/periodic CSI reports may be concatenated in the assumed transmission order of PUCCHs, and may be multiplexed in the first (split) PUSCH instance.

Method B.5-7: The PUSCH instance in Method B.5-2 may be the first PUSCH instance among PUSCH instances sharing the same RV among PUSCH instances temporally overlapping with the PUCCH.

The PUSCH occasion may consist of PUSCH instances for several RVs, and one RV may be transmitted in one or more PUSCH instances. Here, several PUSCH instances corresponding to one RV may be referred to as a PUSCH instance subset. This may be used as a unit in which UCI is multiplexed in PUSCH instance(s).

When a PUCCH temporally overlaps with PUSCH instances, the earliest PUSCH instance may be selected from among the PUSCH instances temporally overlapping with the PUCCH. If UCI is multiplexed in the corresponding PUSCH instance, Method B.5-3 may be applied. Meanwhile, according to Method B.5-7, a PUSCH instance subset to which the corresponding PUSCH instance belongs may be derived, and the UCI may be multiplexed in the earliest PUSCH instance among the PUSCH instances belonging to the subset. Coded bits mapped to the PUSCH instance a may be determined only by an index of the RV from the circular buffer. For other PUSCH instances belonging to the same PUSCH instance subset, the start positions of the mapped coded bits may be derived according to the index of the RV and the numbers of coded bits mapped in the previous PUSCH instances.

Meanwhile, UCI may be multiplexed in two or more PUSCH instances, and this case is illustrated in FIGS. 16A and 16B. Since Method B.5-8 below interprets a PUSCH occasion as one PUSCH, UCI may be multiplexed even in a PUSCH instance which a PUCCH does not overlap in time.

Method B.5-8: In case of a TB included in two or more (mini-) slots (or when one RV is transmitted in two or more (mini-) slots), UCI may be multiplexed in all PUSCH instances.

If one PUSCH occasion temporally overlaps with several PUCCHs in several slots, the terminal needs to multiplex all UCIs in all overlapping PUSCH instances. In this case, Method B.5-8 may be further subdivided into Method B.5-9 and Method B.5-10.

Method B.5-9: In Method B.5-8, the amount of UCI and/or UCI type that can be multiplexed in the PUSCH occasion may be limited. Up to one HARQ codebook and/or one aperiodic/periodic CSI report may be multiplexed in all overlapping PUSCH instances.

Method B.5-10: In Method B.5-8, the amount of UCI and/or UCI type that can be multiplexed in the PUSCH occasion may not be limited. HARQ codebooks may be concatenated or aperiodic/periodic CSI reports may be concatenated in the assumed transmission order of PUCCHs, and may be multiplexed in all overlapping (split) PUSCH instances.

In an example, the UCI may be mapped in each PUSCH instance belonging to the PUSCH occasion, so that data to be mapped to the PUSCH instance may be rate-matched or punctured. When the amount of UCI is 3 bits or more, data may be rate-matched, otherwise, the data may be punctured. Here, when the rate matching is performed for the data and the TB is transmitted in two or more (mini-) slots, an RV may be separately assigned. That is, the RV may vary according to the PUSCH instance.

When the proposed Method B.5-2 is applied, the UCI may be multiplexed in one PUSCH instance. A method in which coded bits for the corresponding PUSCH instance are derived from the circular buffer will be described. In the circular buffer, the start position of the coded bits may vary according to the RV, and the position of REs to which the coded bits are mapped may vary according to an existence of a PUCCH.

In an example, since the number of REs to which the data is mapped is reduced, the position of the REs to which the first coded bit derived from the circular buffer is mapped may vary according to the existence of UCI. In another example, the position of the RE to which the first coded bit is mapped may not vary regardless of the existence of UCI.

### (5.1) UCI Rate Matching for PUSCH

A HARQ-ACK timing may be determined by applying a (sub) slot offset indicated by a DCI or RRC signaling to a (sub) slot to which the last PDSCH instance to which a TB is mapped belongs.

In order to reduce inter-modulation distortion (IMD) or PAPR in a UL signal/channel, the terminal may multiplex UCI in a PUSCH so that a PUCCH for transmitting the UCI and a PUSCH for transmitting a TB are not transmitted simultaneously. If the PUCCH and the PUSCH overlap in some symbol(s), the UCI of the PUCCH may be mapped to the PUSCH.

The number of REs used by the UCI may be determined using various parameters, and REs used by the TB may be determined as the remaining REs. For example, in case of a HARQ-ACK, Equation 1 may be applied. O_{ACK} is the number of HARQ-ACKS, L_{ACK} is the length of CRC, M_{sc}^{UCI}(l) is the number of subcarriers of the 1-th symbol, Kᵣ is the size of the r-th code block, N_{symb,all}^{PUSCH} is the number of symbols of the PUSCH, C_{UL-SCH} is the number of code blocks of the TB, and l₀ is an index of the first symbol not including a DM-RS (or the first index after DM-RS symbol(s)). Here, β_{offset}^{PUSCH} (or beta offset) roughly represents a ratio of an effective code rate of offset the HARQ-ACK to a code rate of the PUSCH, several values therefor may be indicated to the terminal by RRC signaling, and one index may indicated to the terminal by a UL-DCI. α (or alpha scaling or scaling) may act as an upper limit so that the HARQ-ACK does not occupy too many REs. One value therefor may be indicated to the terminal by RRC signaling.

In addition to the HARQ-ACK, since similar equations (i.e., Equation 2, Equation 3, Equation 4, Equation 5, Equation 6) may be applied to other UCI types (i.e., SR, L1-RSRP, CSI), all methods described below may be easily extended and applied.

Equation 1 may be related to the number of REs when the HARQ-ACK is mapped to a PUSCH to which a UL-SCH is mapped, Equation 2 may be related to the number of REs when the HARQ-ACK is mapped to a PUSCH to which a UL-SCH is not mapped, Equation 3 may be related to the number of REs when a CSI part 1 is mapped to a PUSCH to which a UL-SCH is mapped, Equation 4 may be related to the number of REs when a CSI part 1 is mapped to a PUSCH to which a UL-SCH is not mapped, Equation 5 may be related to the number of REs when a CSI part 2 is mapped to a PUSCH to which a UL-SCH is mapped, and Equation 6 may be related to the number of REs when a CSI part 2 is mapped to a PUSCH to which a UL-SCH is not mapped.

$${Q}_{A C K}^{′} = min \{ ⌈ \frac{( {O}_{A C K} + {L}_{A C K} ) \cdot {β}_{offset}^{PUSCH} \cdot {\sum }_{l = 0}^{{N}_{s y mb , all}^{PUSCH} - 1} {M}_{s c}^{UCI} ( l )}{{\sum }_{r = 0}^{{C}_{UL - SCH} - 1} {K}_{r}} ⌉ , ⌈ α \cdot {\sum }_{{l}_{0} = 0}^{{N}_{symb , all}^{PUSCH} - 1} {M}_{sc}^{UCI} ( l ) ⌉ \} \qquad [ Equation 1 ]$$

$${Q}_{A C K}^{′} = min \{ ⌈ \frac{( {O}_{A C K} + {L}_{A C K} ) \cdot {β}_{offset}^{PUSCH} \cdot {\sum }_{l = 0}^{{N}_{s y mb , all}^{PUSCH} - 1} {M}_{s c}^{UCI} ( l )}{R \cdot {Q}_{m}} ⌉ , ⌈ α \cdot {\sum }_{{l}_{0} = 0}^{{N}_{symb , all}^{PUSCH} - 1} {M}_{sc}^{UCI} ( l ) ⌉ \} \qquad [ Equation 2 ]$$

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{s y mb , all}^{PUSCH} - 1} {M}_{s c}^{UCI} ( l )}{{\sum }_{r = 0}^{{C}_{UL - SCH} - 1} {K}_{r}} ⌉ , ⌈ α \cdot {\sum }_{{l}_{0} = 0}^{{N}_{symb , all}^{PUSCH} - 1} {M}_{sc}^{UCI} ( l ) ⌉ - {Q}_{A C K}^{′} \} \qquad [ Equation 3 ]$$

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {{\sum }^{{N}_{s y mb , all}^{PUSCH} - 1}}_{{l}_{0} = 0} {M}_{s c}^{UCI} ( l ) - {Q}_{A C K}^{′} \} \\ if CSI part 2 is on PUSCH , or {{\sum }^{{N}_{s y mb , all}^{PUSCH} - 1}}_{{l}_{0} = 0} {M}_{s c}^{UCI} ( l ) - {Q}_{A C K}^{′} if CSI part 2 is not on PUSCH \qquad [ Equation 4 ]$$

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{s y mb , all}^{PUSCH} - 1} {M}_{S C}^{UCI} ( l )}{{\sum }_{r = 0}^{{C}_{UL - SCH} - 1} {K}_{r}} ⌉ , ⌈ α \cdot {\sum }_{{l}_{0} = 0}^{{N}_{symb , all}^{PUSCH} - 1} {M}_{S C}^{UCI} ( l ) ⌉ - {Q}_{A C K}^{′} - {Q}_{CSI - 1}^{′} \} \qquad [ Equation 5 ]$$

$${Q}_{CSI - 2}^{′} = {\sum }_{{l}_{0} = 0}^{{N}_{s y mb , all}^{PUSCH} - 1} {M}_{sc}^{UCI} ( l ) - {Q}_{A C K}^{′} - {Q}_{CSI - 1}^{′} \qquad [ Equation 6 ]$$

When UCI is multiplexed in a PUSCH, not only a beta offset but also alpha scaling is applied, so that the number of REs occupiable by the encoded UCI may be determined. The alpha scaling is used to determine an upper limit of the number of REs. For example, when a beta offset is indicated so that only too few REs are allocated to the TB belonging to the PUSCH, or when there are few REs of the PUSCH that cannot follow the indicated beta offset, the upper limit of alpha scaling may be used.

Here, Kᵣ corresponding to the denominator of Equations 1, 2, 3, 4, and 5 means the size of the code block, and C_{UL-SCH} means the number of code blocks. This may be applied when one TB is included in the PUSCH. According to the existing technical specification, all code blocks are included in a split PUSCH instance, and a rate matching procedure therefor may be performed. In this case, both the rate matching of the UCI and the TB are performed to generate guard bits.

If one TB is transmitted in two or more slots or PUSCH instances, C_{UL-SCH} may be interpreted as the number of code blocks derived from the TB, or interpreted as the number of code blocks that one split PUSCH instance has. This is expressed in Method B.5-11 and Method B.5-12 below. Methods B.5-11 and B.5-12 may be applied individually or together.

Method B.5-11: In the equation for calculating Q′, the number of code blocks belonging to one split PUSCH instance is interpreted as C_{UL-SCH}.

If the number of code blocks derived from the TB is C, and the split PUSCH instance has only C′ (<C) code blocks, for multiplexing with UCI, Equation 1, Equation 2, Equation 3, Equation 4, Equation 5, and Equation 6 may be calculated from C′. Here, C′ is interpreted as C_{UL-SCH}.

When one code block is mapped to different split PUSCH instances, C′ may be expressed as a natural number through a round off, a round above, or a round operation to the nearest integer.

In order to apply Method B.5-11, the relationship C′<C should be premised. However, Method B.5-12 below may be applied even when C′≤C.

Method B.5-12: In the equation for calculating Q′, the number of symbols belonging to one split PUSCH instance is interpreted as N_{symbol,all}^{PUSCH}.

When deriving the effective code rate of the UCI, it may be derived as a relative value from the effective code rate of the TB in the corresponding split PUSCH instance. Therefore, in order to derive the effective code rate that the TB has in the split PUSCH instance, Q′ may be derived using the number of REs belonging to the split PUSCH instance. This means that when interpreting N_{symbol,all}^{PUSCH}, it is interpreted as the number of symbols included in the split PUSCH instance in which the UCI is transmitted.

If the UCI is multiplexed in two or more split PUSCH instances, in order to obtain the effective code rate of the TB, the number of REs belonging to the corresponding split PUSCH instance may be utilized to derive Q′. This means that when interpreting N_{symbol,all}^{PUSCH}, it is interpreted as the number of symbols included in the split PUSCH instance in which the UCI is transmitted.

Here, in order to obtain the effective code rate of the TB, the TB size (i.e., Σᵣ₌₀^{C}^{_{UL-SCH}}⁻¹ Kᵣ) may be divided by the number of (mini-) slots in which one TB is transmitted, thereby deriving Q′. In this case, it may be calculated as

$$\frac{1}{N s} \cdot {\sum }_{r = 0}^{{C}_{UL - SCH} - 1} {K}_{r} .$$

When Q′ is derived for each UCI type, the number of OFDM symbols to which the corresponding UCI type is mapped may be derived in consideration of M_{sc}^{UCI}(l).

For HARQ-ACK, SR, CG-UCI, and/or CSI part1, Q′ may be derived. When a quotient and a remainder obtained by dividing Q′ by M_{sc}^{UCI}(l) are referred to as q and r, respectively, all subcarriers are used in q (q≥0) symbols, and r (0≤r<M_{sc}^{UCI}(l)) subcarriers may be used in any one symbol. Here, q symbols may be divided by the number of split PUSCH instances. If transmitted in n slots (or n split/full PUSCH instances), q symbols may be divided into n parts. When a quotient and a remainder obtained by dividing q by n are respectively referred to as qn and nn, nn PUSCH instances among n PUSCH instances may correspond to (qn+1) symbols, and the remaining (n−nn) PUSCH instances may correspond to qn symbols. In addition, r subcarriers may be used in one symbol for any one PUSCH instance among the remaining (n−nn) PUSCH instances. Here, the r subcarriers may be subcarriers spaced at equal intervals from among M_{sc}^{UCI}(l) subcarriers.

Also for the CSI part2, Q′ may be derived. The terminal may map the CSI part2 only to subcarriers and symbols to which the HARQ-ACK, SR, CG-UCI, and/or CSI part1 are not mapped.

### (6) ULCI Interpretation

The base station may support both URLLC traffic and eMBB traffic. The base station may schedule a terminal supporting URLLC traffic and a terminal supporting eMBB traffic in the same carrier. In this case, the base station may indicate (configure) through RRC signaling so that the terminal supporting eMBB traffic observes a separate DCI.

Here, the separate DCI may mean a DCI including a downlink preemption indicator (DLPI) for a PDSCH and a DCI including an uplink cancellation indicator (ULCI) for a PUSCH. Since they have different RNTIs, the terminal can receive only one DCI.

The ULCI may be expressed as a bitmap, each bit of the bitmap corresponds to a UL resource, and a value of the bit may indicate to the terminal whether the terminal can transmit the PUSCH or should drop the PUSCH. If some of REs of the PUSCH to be transmitted by the terminal are included in UL resources expressed by the bitmap, the terminal may not transmit the PUSCH in the REs. Depending on an implementation of the terminal, the terminal may transmit or drop the PUSCH in the remaining REs of the PUSCH. If one TB is repeatedly transmitted in two or more subslots or mini-slots, a PUSCH instance may be transmitted or dropped as a unit.

In case of a PUSCH in which one TB is transmitted in two or more subslots or mini-slots, the ULCI may be applied in more detail.

Method B.6-1: The ULCI is applied on a PUSCH instance basis, and the entire PUSCH instance allowed by the ULCI to be transmitted may be transmitted.

By interpreting the transmission of the TB as a PUSCH occasion, it is possible to appropriately introduce a PUSCH instance. This may be regarded as determining a PUSCH instance at a boundary between invalid symbols (invalid resources) to which the PUSCH cannot be mapped and valid symbols (or valid resources) or (mini, sub) slots. Thereafter, the method of applying the ULCI to the PUSCH instance may follow the existing technical specification. According thereto, a PUSCH instance whose entire part the terminal can transmit and a PUSCH instance whose part is to be dropped may be distinguished.

Method B.6-2: The ULCI is applied on a PUSCH basis, and the entire PUSCH instance that is not allowed by the ULCI to be transmitted may not be transmitted.

If a portion of the PUSCH cannot be transmitted according to the ULCI, the entire PUSCH may not be transmitted. That is, the PUSCH is interpreted as a PUSCH occasion, and for a PUSCH composed of several PUSCH instances, the terminal may drop all PUSCH instances. The difference between Method B.6-1 and Method B.6-2 may be determined by whether a unit to which the ULCI is applied is a PUSCH instance or a PUSCH (or PUSCH occasion).

Method B.6-3: The ULCI is applied in units of a subset of PUSCH instances sharing one RV, and transmission thereof may not be allowed by the ULCI.

Based on a time when the ULCI is received and reflected to the terminal, all or part of a specific PUSCH instance may not be transmitted. According to Method B.6-3, a subset to which the corresponding PUSCH instance belongs may be derived, and all PUSCH instances included in the corresponding subset may be affected by the ULCI. That is, all PUSCH instances that are being transmitted or are scheduled to be transmitted may be canceled after the ULCI is reflected to the terminal.

### Measurement Outside Active BWP

When a bandwidth supported by the terminal (e.g., RedCap terminal) is narrow, the base station may configure and activate a BWP having a narrow bandwidth for the terminal. The base station may support not only the RedCap terminal but also a general terminal. The BWP configured and activated for the general terminal may have a wider bandwidth than the BWP used by the RedCap terminal. That is, a bandwidth of a carrier used by the base station may be wider than the bandwidth of the BWP used by the RedCap terminal. In this case, it may be preferable for the base station to know which RBs the BWP used by the RedCap terminals should be composed of.

Therefore, some terminals should be able to receive a DL RS (e.g., SS/PBCH, CSI-RS, TRS) even in RBs that do not belong to the configured and activated BWP. It may be preferable that the terminals generate a CSI report or an RRM measurement report based on the received and measured DL-RS and transmit it to the base station.

The base station may change the BWP used by the corresponding terminals (mainly RedCap terminals) by using the RRM measurement results and CSI reported from the terminals. In this case, both a diversity gain and a scheduling gain can be achieved.

### (1) CSI Measurement

In the BWP configured for the terminal, a control channel, data channel, and RS may all be configured. According to the existing technical specification, the terminal may be indicated (or configured) several BWPs by RRC signaling, and a CSI-RS, SRS, or the like as well as a PDCCH, PDSCH, and PUSCH may be separately indicated (or configured) for each BWP. The terminal may perform transmission or reception only within the BWP.

For example, in case of an SS/PBCH block, the terminal may not switch to a separate BWP. The terminal may receive an SS/PBCH block and derive an initial BWP from the received SS/PBCH block. Such a procedure may be utilized when the terminal performs a cell search or handover.

When the terminal needs to measure an RB that does not belong to the activated BWP, the terminal may perform switching to another non-activated BWP and receive a corresponding DL RS according to configuration of the DL RS belonging to the switched BWP.

For example, when the terminal needs to receive a CSI-RS, the operation of the terminal may consist of several steps.

In the first step, the terminal may switch from a DL BWP1 activated to the terminal to a DL BWP2 in which a CSI-RS to be received is configured. In the second step, the terminal may receive the CSI-RS from the base station in the DL BWP2. The terminal may generate a CSI report (later) by using the received CSI-RS. In the third step, the terminal may switch back to the DL BWP1 from the activated DL BWP2. Here, a UL BWP in which the CSI report is transmitted may be associated with the DL BWP1 or the DL BWP2, or may be associated with only the DL BWP1.

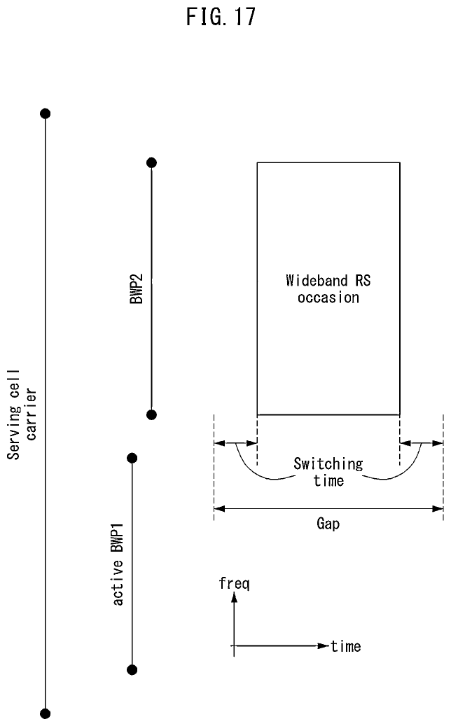

FIG. 17 is a conceptual diagram illustrating an exemplary embodiment of receiving a DL RS or transmitting a UL RS in RB(s) not belonging to an activated BWP.

Referring to FIG. 17, a wideband DL RS should be received in RB(s) not belonging to a BWP1, and the terminal may receive the DL RS by activating a BWP2. Before and after the switching process between the BWPs, the terminal may consume a predetermined amount of time and may not be able to receive a DL signal/channel from the base station. Here, the BWP2 in which the wideband DL RS is received may be composed of RBs including a part of the BWP1 or the entire BWP1.

In addition, a wideband UL RS should be transmitted in RB(s) not belonging to the BWP1, and the terminal may transmit the UL RS by activating the BWP2. Before and after the switching process between the BWPs, the terminal may consume a predetermined amount of time and may not be able to receive a DL signal/channel from the base station. Here, the BWP2 in which the wideband UL RS is transmitted may be composed of RBs including a part of the BWP1 or the entire BWP1.

According to the existing technical specification, the terminal may switch the activated BWP based on an indication of the base station or a timer. However, in order to receive only the DL RS or to transmit only the UL RS, the terminal may need to autonomously change the activated BWP and change the activated BWP again, even if the base station is not involved.

Method C.1-1: The terminal may switch from an activated BWP to a non-activated BWP in order to receive a DL RS or transmit a UL RS, and then activate the original BWP again.

Here, the DL RS may be a periodic RS or a semi-persistent RS. Alternatively, the DL RS may be an aperiodic RS triggered by a DCI. When the DL RS is a CSI-RS, the CSI-RS may be a non-zero-power (NZP) CSI-RS.

In order for the terminal to change the DL BWP, a predetermined time defined in the technical specification is required. For example, different time values may be applied to a case of switching from the BWP1 to the BWP2, a case of switching from the BWP2 to the BWP1, or a case of switching between a carrier defined in FR1 and a carrier defined in FR2.

The time required for the terminal to receive a DL RS that does not belong to the bandwidth of the activated DL BWP may be shorter than the maximum time (required for BWP switching) defined in the technical specification. The reason is that the DL RS and the activated DL BWP may have the same subcarrier spacing. That is, when the bandwidth of the DL RS is smaller than a processing capability (e.g., RF bandwidth) of the terminal, the terminal may change only the bandwidth while switching the DL BWP, so that the terminal can receive the DL-RS by consuming only a time shorter than a time required to change both the bandwidth and the subcarrier spacing.

Method C.1-2: The bandwidth of the DL RS (or UL RS) configured for the terminal may be wider than the bandwidth of the DL BWP (or UL BWP).

Accordingly, the terminal may receive the DL RS or transmit the UL RS without switching the BWP. To this end, frequency resources of the DL RS should be indicated to the terminal. The terminal may assume that the DL RS is received even if PRB(s) in which the DL RS is received do not belong to the frequency resources of the BWP. The RB(s) in which the DL RS is received may be defined by a CRB grid. Alternatively, the RB(s) in which the DL RS is received may be defined by a PRB grid, and parameters representing the frequency resources of the DL RS may be given based on the CRB grid.

When generating a CSI report, the terminal may consider a CSI part 2. For example, for subband PMI reporting, a range of the subband should include a bandwidth in which the DL RS is received.

To this end, when generating the CSI report, the terminal may assume a virtual DL BWP composed of PRB(s) in which the CSI-RS is received. The subband PMI reporting may be generated for the virtual DL BWP. Similarly, the terminal may assume a virtual UL BWP in which a UL RS is transmitted. The virtual DL or UL BWP may mean a BWP required to represent the PRB(s) to which the DL RS or UL RS is mapped, not an actual BWP to which the terminal should be switched in order to receive the DL RS or transmit the UL RS.

Method C.1-3: When configuring a DL RS or UL RS to the terminal, a BWP including their frequency resources may be separately associated.

### Cross Duplexing Interpretation Method

### (1) Slot Pattern Interpretation Method

In a system operating in the TDD mode, the terminal may be configured with a pattern of a slot through RRC signaling. Additionally, the terminal may receive a DCI (e.g., DCI format 2_0), and perform DL reception or UL transmission in a symbol configured as an FL symbol within the slot. The operation of the terminal according to the existing technical specification is exemplified in Table 2.

An index included in DCI format 2_0 should indicate a DL symbol configured to the terminal through RRC signaling as the DL symbol. In addition, an index included in DCI format 2_0 should indicate a UL symbol configured to the terminal through RRC signaling as the UL symbol. On the other hand, in the FL symbol configured to the terminal through RRC signaling, a DL signal/channel may be allowed to be received by an index included in DCI format 2_0. Alternatively, in the FL symbol configured to the terminal through RRC signaling, a UL signal/channel may be allowed to be transmitted by an index included in DCI format 2_0. Here, the terminal should consider only a DL signal/channel and/or a UL signal/channel allocated by a scheduling DCI.

Table 2 is describing a method of interpreting a transmission/reception direction of a symbol when a DCI format 2_0 is configured to be received.

TABLE 2

| | Semi-static DL | Semi-static UL | Semi-static FL |
|---|---|---|---|
| Dynamic | DCI based DL | N/A | DCI based DL |
| DL | reception | | reception |
| | Configured DL | | |
| | reception | | |
| Dynamic | N/A | DCI based UL | DCI based UL |
| UL | | transmission | reception |
| | | Configured UL | |
| | | transmission | |
| Dynamic FL | N/A | N/A | Configured PRS |

If an additional DCI is not received, the terminal assumes only DL/FL/UL configured through RRC signaling. Accordingly, it may not be allowed to receive a DL signal/channel in an FL symbol, and it may not be allowed to transmit a UL signal/channel in an FL symbol.

The UL coverage may be limited while the terminal operates in the full-duplex scheme or half-duplex scheme. In this case, it may be preferable to be able to utilize more FL symbols as UL symbols. When a specific slot is composed of DL symbol(s), FL symbol(s), and UL symbol(s), a system in which specific subcarrier(s) of the FL symbol(s) can be utilized for downlink transmission and other specific subcarriers(s) can be utilized for uplink reception may be considered.

Here, the terminal may be assumed to operate in the full-duplex scheme but may be assumed to operate in the half-duplex scheme when separately mentioned.

(2) Configuration in which DL Reception and UL Transmission are Performed in a Non-FL Symbol

Consider a case where there are two or more consecutive FL symbols within a slot. This is because there may be no symbol corresponding to a guard time if both DL reception and UL transmission are performed in one FL symbol.

Method D.2-1: FL symbols may be configured in the order of (subcarrier(s) for performing DL reception (i.e., DL subcarrier(s)) and FL subcarrier(s)), (DL subcarrier(s), FL subcarrier(s), and subcarrier(s) for perform UL transmission (i.e., UL subcarrier(s))), or (FL subcarriers and UL subcarriers).

Considering specific FL symbols, guard subcarrier(s) (or guard tone(s)) may be required between DL reception and UL transmission. Therefore, it may be preferable in terms of transmission efficiency to reduce the number of guard subcarrier(s). For this, it may be preferable that the number of boundaries at which DL and UL are switched is small.

Method D.2-2: A switching between DL reception and UL transmission in FL symbols may be allowed only once at most.

If both DL reception and UL transmission are allowed in FL symbol(s), the UL transmission may be preferably performed in subcarriers having a lower frequency so that a reception SINR of a UL signal/channel increases at the base station.

Method D.2-3: In Method D.2-2, UL transmission may be allowed in PRB(s) with a lower frequency.

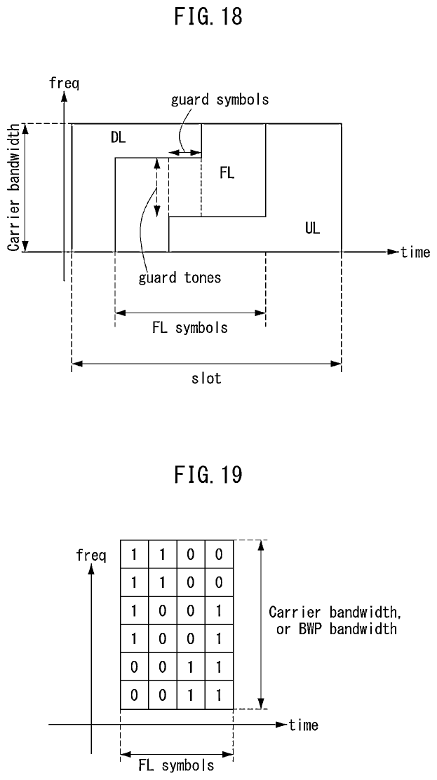

FIG. 18 is a conceptual diagram illustrating an exemplary embodiment of a configuration of resource allocation in which DL transmission and UL reception can be performed in FL symbols of a specific slot.

Referring to FIG. 18, an example in which both DL reception and UL transmission are performed in semi-static FL symbols is shown. The FL symbols may be consecutively located, and the FL symbols may be located between DL symbol(s) and UL symbol(s). A region in which a UL signal/channel can be transmitted may be allocated to a lower frequency, and a region in which a DL signal/channel can be received may be allocated to a higher frequency. Here, since the terminal may operate in the half-duplex scheme, it may not transmit a UL signal/channel while receiving a DL signal/channel.

FL symbols and/or UL symbols may be referred to as non-DL symbols. In an exemplary embodiment, a non-DL symbol may mean only an FL symbol or an FL symbol and a UL symbol.

For subcarriers belonging to non-DL symbols, an arbitrary DL/UL pattern, Method D.2-2, or Method D.2-3 may be applied. The base station may configure this pattern to terminals by RRC signaling or may indicate it to them by using a DCI. For convenience of description, this DCI may be referred to as a DCI format x.

By RRC signaling, the terminal may know in which region (i.e., REs) DL reception is allowed and UL transmission is allowed in a DL BWP and UL BWP configured to the terminal.

Method D.2-4: BWP configuration may include information on a DL region and a UL region that can be allowed in non-DL symbols.

The base station may determine which subcarriers of non-DL symbols to be placed in the DL region or the UL region according to a traffic condition or a position of the terminal. This may be indicated to the terminal by a DCI. The base station may indicate it to the terminal by using a group common DCI or UE-specific DCI. For example, the DCI format x may be the DCI format 2_0.

In another example, the DCI format x may be the DCI format 2_1 or DCI format 2_4. The DCI format 2_4 may be received by several terminals, and may indicate a pattern of resources in which UL transmission is allowed or not.

Method D.2-5: The terminal may know a pattern (DL, FL, UL) for subcarriers of non-DL symbols by receiving a DCI.

In the DCI format x, a pattern of slots may be included as an index. More specifically, indexes to be interpreted by several terminals may be concatenated to form a DCI, and each index may be interpreted as a pattern of slots. Each terminal may be configured through RRC signaling to determine where information should be obtained from the DCI.

Method D.2-6: For a given non-DL symbol, a pattern for subcarriers may be known by an index.

An index derived from a start index of a PRB or CRB and the number of consecutive RBs may be given for each FL symbol. In this manner, since many indexes should be provided when the number of FL symbols is large, a signaling burden may be large.

To solve this problem, a method of deriving a pattern for subcarriers from information having a fixed size may be considered.

Method D.2-7: For a given non-DL symbol, a pattern for subcarriers may be known by a 2D bitmap.

The length of the 2D bitmap may be configured by RRC signaling to the terminal. One bit may correspond to a set of REs expressed by consecutive symbols and consecutive subcarriers. Here, one value of each bit of the bitmap means that the use for DL and UL in the set of REs corresponding to the bit is allowed, and another value thereof means that the use is not allowed.

Method D.2-8: In Method D.2-7, the total length of the 2D bitmap and the length of one axis thereof (i.e., the number of consecutive symbols or the number of consecutive subcarriers) may have independent values, and may be configured by RRC signaling to the terminal.

FIG. 19 is a conceptual diagram illustrating an exemplary embodiment in which characteristics of subcarriers are represented in a bitmap with respect to consecutive non-DL symbols.

Referring to FIG. 19, one value (e.g., ‘1’) set to each bit of the bitmap may indicate that utilization for DL and UL is allowed, and another value (e.g., ‘0’) may indicate that utilization for DL and UL is not allowed. According to Method D.2-3, a region corresponding to the bit set to 1 may be interpreted as being utilized for UL transmission in a low-frequency region and may be interpreted as being utilized for DL reception in a high-frequency region. Conversely, 0 and 1 may be interpreted interchangeably, and DL and UL may be interpreted interchangeably.

The arrangement of 1's and 0's in a pattern of subcarriers at a given time (or non-DL symbols) may be limited. That is, the positions of 0's may be restricted to a configuration in which consecutive 1 (s), consecutive 0 (s), and consecutive 1 (s) are arranged, a configuration in which consecutive 0 (s) and consecutive 1 (s) are arranged, or a configuration in which consecutive 1 (s) and consecutive 0 (s) are arranged in the order of increasing frequency at a given time. In addition, the positions of 0's may be restricted to a configuration in which consecutive 1 (s), consecutive 0 (s), and consecutive 1 (s) are arranged, a configuration in which consecutive 0 (s) and consecutive 1 (s) are arranged, or a configuration in which consecutive 1 (s) and consecutive 0 (s) are arranged in the order of increasing time at a given frequency.

Accordingly, a temporal order of (DL, FL, and UL) may be satisfied at a given frequency, and at the same time, a frequency order of (DL, FL, and UL) (or UL, FL, and DL) may be satisfied at a given time. This may be summarized by Method D.2-9. In addition, the positions of 0's expressed as FL may be arranged adjacent to each other in the time and frequency domains, and consecutive 0's may not be interrupted by being surrounded by 1's in the time or frequency domain.

Method D.2-9: In Method D.2-7, the method in which the values of the bitmap are arranged may satisfy a rule in which a pattern for a time at a given frequency and a pattern for a frequency at a given time are the same.

Method D.2-10: In Method D.2-9, time and frequency resources divided by FL may not be divided by resources divided by UL and DL.

Here, since numerologies of a DL BWP and a UL BWP may be different from each other, a reference numerology may be applied. Accordingly, the number of symbols and subcarriers corresponding to one bit may vary depending on when interpreted as DL or when interpreted as UL.

The above method may express the characteristics of subcarriers for consecutive FL symbols in one slot. When the DCI format x is used, since a pattern of several consecutive slots is derived from one index, the characteristics of the FL symbols may also be included for each slot.

The number (e.g., N) of slots may be configured to the terminal through RRC signaling, and a pattern for N slots may be derived by one index. For example, N may not be greater than maxNrofSlotFormatsPerCombination.

Alternatively, a periodicity at which the DCI format x is received by the terminal through RRC signaling may be configured, and an index derived from the DCI format x may be interpreted for non-DL symbols belonging to one period. For example, when the periodicity at which the DCI format x is received is y slots, non-DL symbols in z units may be distinguished. Here, one unit may mean consecutive FL symbols, and the value of z may be derived differently for each slot pattern. The terminal may apply the index derived from the DCI format x to FL symbols belonging to one unit. Accordingly, a size of a resource for which the index is interpreted (i.e., the number of symbols and/or the characteristics of subcarriers) may be different for each slot pattern.

In order to derive the characteristics of the non-DL symbols for the N slots, the DCI format x may include N 2D bitmaps that can be read by the terminal. Alternatively, the terminal may read one 2D bitmap from the DCI format x, so that the characteristics of all non-DL symbols may be equally applied in N slots.

Method D.2-11: The terminal may derive one 2D bitmap from the DCI format x, and accordingly, the characteristics of the non-DL symbols may be equally applied to N slots.

The 2D bitmap may be expressed as a 1D bit stream according to a predetermined rule. This may be interpreted by one or several terminals. Alternatively, several 1D bit streams may be concatenated. There may be one or more terminal group(s) corresponding to one 2D bitmap or one 1D bit stream.

According to another method, an RB set is indicated to the terminal through RRC signaling, and PRBs interpreted as DL PRBs and UL PRBs may be identified from the RB set for non-DL symbols. The DL PRBs and the UL PRBs may consist of only subcarriers capable of receiving a DL signal/channel, and may consist only of subcarriers capable of transmitting a UL signal/channel, respectively. A DL signal/channel or a UL signal/channel is not allocated to PRBs that do not belong to them, and they may be used as guard tones. The RB set may be configured only for the reference numerology or configured for each subcarrier spacing, and may be determined by a start CRB index calculated from the point A and the number of consecutive CRBs. That is, the RB set may be defined by the CRB grid. The start RB index and the number of consecutive RBs may be indicated to the terminal as an index. The start RB index and the number of consecutive RBs may be derived from the index.

As an example, RBs belonging to DL may be indicated to the terminal by an index. As another example, RBs belonging to DL and RBs belonging to UL may be indicated to the terminal by different indices. As yet another example, RBs belonging to DL, RBs belonging to FL, and RBs belonging to UL may be indicated to the terminal by different indexes.

### (3) Uplink Transmission Method

Based on RRC signaling or a combination of RRC signaling and DCI format 2_0, the terminal may derive FL symbol(s). According to the DCI format 2_0, the terminal may receive a DL signal/channel and may transmit a UL signa/channel by a scheduling DCI even in FL symbols. Similarly, even when configured through RRC signaling or indicated by a scheduling DCI to repeatedly perform reception or transmission, transmission/reception by a scheduling DCI may be allowed even in FL symbols.

However, operations by a configured grant cannot use FL symbols. That is, in the FL symbols, reception of a DL signal/channel and transmission of a UL signal/channel by a configured grant are not allowed. Similarly, even when configured or indicated to the terminal to be repeatedly received or transmitted, operations by a configured grant is not allowed in FL symbols.

When the proposed method is applied, transmission/reception may be allowed in some subcarriers belonging to FL symbols, and this may be applied also to a configured grant. The terminal may or may not be configured to receive a DCI (e.g., DCI format 2_0) indicating that DL/UL is allowed in FL symbols. For convenience of description, this DCI is referred to as a DCI format x.

Method D.3-1: When the DCI format x is not configured to the terminal, the terminal may not perform transmission/reception by a configured grant in FL symbol(s). When the DCI format x is configured to the terminal, the terminal may perform transmission/reception according to a configured grant in consideration of a pattern of subcarriers of FL symbol(s).

Operations by a Configured grant may be applied to not only data channels such as a semi-persistent scheduled (SPS) PDSCH, configured grant type-1 (CGT-1) PUSCH, configured grant type-2 (CGT-2) PUSCH, and/or SS/PBCH block(s) but also to control channels. Such the examples may include a HARQ-ACK for an SPS PDSCH, semi-persistent CSI, periodic CSI, SRS, and/or PRACH.

Method D.3-2: In the method of counting the number of transmissions in Method D.3-1, if transmission and reception are allowed in FL symbol(s), it may be included in counting the number of transmissions.

A method for counting the number of times for DL reception and UL transmission may be classified into two schemes according to the existing technical specification. According to one scheme of counting the number of UL transmissions, UL transmission may be performed only on a valid resource among time resources allocated to the terminal, and a UL transmission that is not performed in an invalid resource may also be counted as being included in the number of transmissions. Here, the valid resource may be a symbol that is a UL symbol and/or a FL symbol and does not belong to an SS/PBCH block and a type-0 PDCCH CSS set. According to another scheme of counting the number of UL transmissions, only UL transmissions actually performed in valid resources may be counted as being included in the number of transmissions, so that the configured number of transmissions may be guaranteed.

When a PUSCH is repeated, it may be classified into a repetition type A and a repetition type B. When the repetition type B is configured, an invalid symbol pattern may be additionally configured to the terminal. The invalid symbol pattern may indicate time resources occurring periodically, and a time resource that overlaps with the PUCCH repetition type B transmitted by the terminal is considered invalid.

In order to perform frequency hopping when transmitting a PUSCH and PUCCH, it may be configured by RRC signaling or may be indicated by a scheduling DCI. In this case, inter-slot frequency hopping, intra-slot frequency hopping, intra-repetition frequency hopping, or inter-repetition frequency hopping for the PUSCH and PUCCH may be performed.

Method D.3-3: When frequency hopping is enabled, if it is determined that a resource belonging to any one frequency hop of a PUSCH (repetition) is invalid, the terminal may not transmit all frequency hops of the PUSCH (repetition).

For example, in FIGS. 18 to 23, a case in which a valid transmission is performed in some FL symbols for a PUCCH repetition, a PUSCH repetition type A, and/or a PUSCH repetition type B is exemplified.

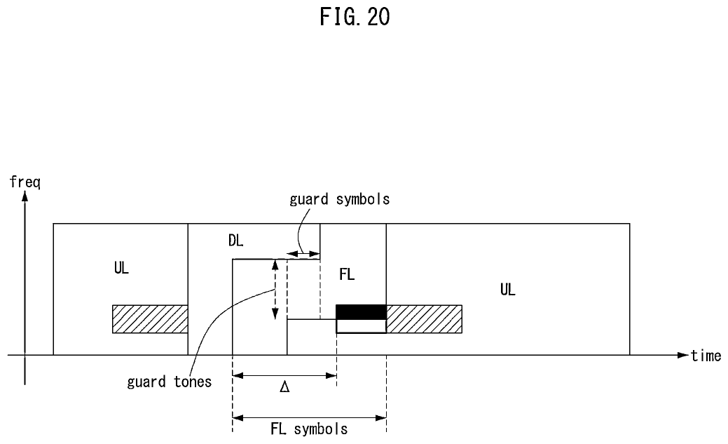

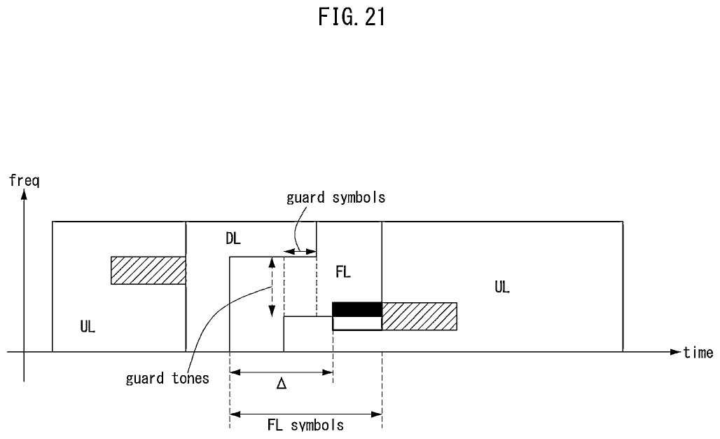

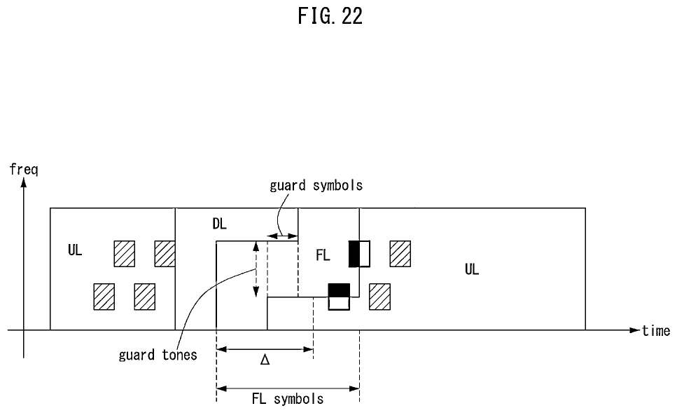

FIG. 20 is a conceptual diagram illustrating an exemplary embodiment in which frequency hopping is not performed in the case of PUSCH repetition type B, FIG. 21 is a conceptual diagram illustrating an exemplary embodiment in which frequency hopping is performed in an inter-repetition scheme in the case of PUSCH repetition type B, and FIG. 22 is a conceptual diagram illustrating an exemplary embodiment in which frequency hopping is performed in an intra-repetition scheme in the case of PUSCH repetition type B.

Referring to FIGS. 20 to 22, a case in which the PUSCH repetition type B is configured is considered. A PUSCH repetition may not be transmitted at a boundary of a slot and a DL symbol. A may be determined as the number of symbols that can be used after an invalid symbol pattern or a DL symbol. In a part of FL symbols, transmission of a PUSCH may be allowed according to subcarriers.

Referring to FIG. 20, frequency hopping is not performed, and some REs may overlap with subcarriers classified as FL in FL symbols. Referring to FIG. 21, frequency hopping is performed, and some REs may overlap with subcarriers classified as FL in FL symbols. Referring to FIG. 22, frequency hopping is performed, some REs may overlap with subcarriers classified as FL in FL symbols. In this case, they may not be resources in which transmission of a PUSCH repetition is allowed. The reason is that transmission of a PUSCH repetition can be allowed only in subcarriers classified as UL in FL symbols. Therefore, the terminal may transmit a PUSCH repetition only in resources determined as valid.

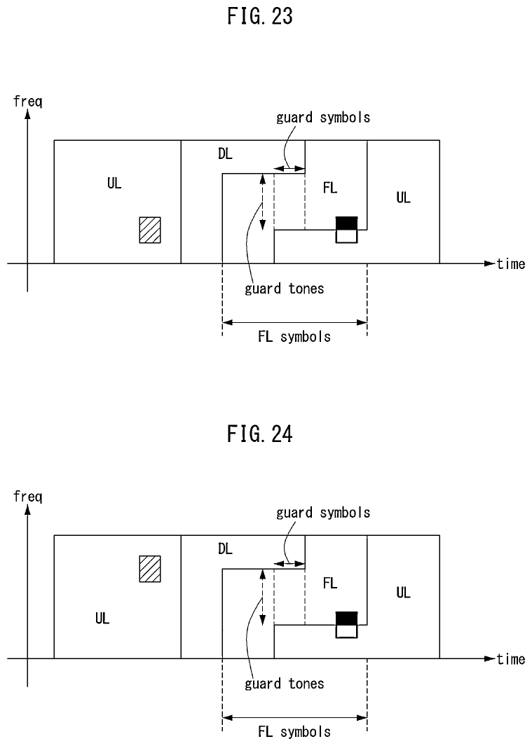

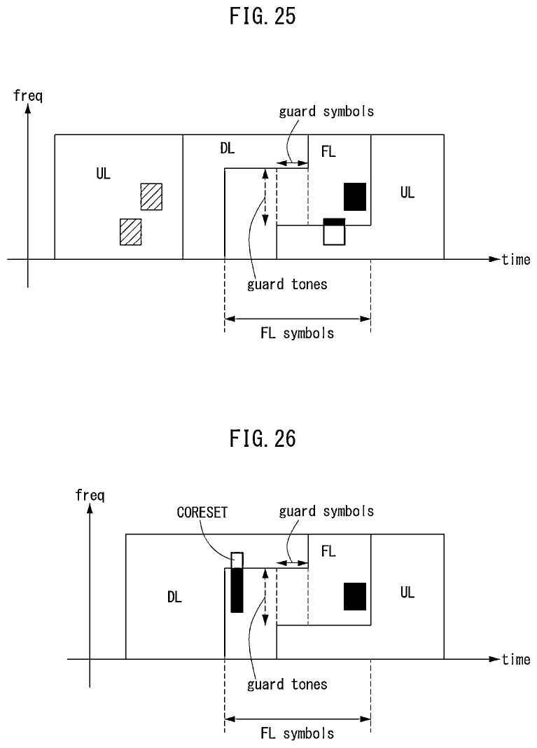

FIG. 23 is a conceptual diagram illustrating an exemplary embodiment in which frequency hopping is not performed in the case of PUSCH repetition type A or PUCCH repetition, FIG. 24 is a conceptual diagram illustrating an exemplary embodiment in which frequency hopping is performed in an inter-slot hopping scheme in the case of PUSCH repetition type A or PUCCH repetition, and FIG. 25 is a conceptual diagram illustrating an exemplary embodiment in which frequency hopping is performed in an intra-slot hopping scheme in the case of PUSCH repetition type A or PUCCH repetition.

Referring to FIGS. 23 to 25, a case in which the PUCCH repetition or PUSCH repetition type A is configured is considered. Here, PUCCH repetitions or PUSCH repetitions adjacent to each other may have an interval of one slot or subslot.

Referring to FIG. 23, frequency hopping is not performed, and some REs may overlap with subcarriers classified as FL in FL symbols. Referring to FIG. 24, frequency hopping is performed, and some REs may overlap with subcarriers classified as FL in FL symbols. Referring to FIG. 25, frequency hopping is performed, and some REs may overlap with subcarriers classified as FL in FL symbols. In this case, they may not be resources in which transmission of a PUSCH repetition or PUCCH repetition is allowed. The reason is that transmission of a PUSCH repetition or PUCCH repetition can be allowed only in subcarriers classified as UL in FL symbols. Therefore, the terminal may transmit a PUSCH repetition or a PUCCH repetition only in resources determined as valid.

### (4) Downlink Reception Method

According to the existing technical specification, the terminal may determine an operation of receiving a CORESET. A case in which the terminal receives a DCI format 2_0 and one symbol (e.g., symbol t) is indicated as a dynamic FL symbol or a dynamic UL symbol may be considered. Reception of a DL signal/channel may not be allowed in the symbol t belonging to the CORESET. Otherwise, the terminal may receive a DL signal/channel by interpreting the symbol t as a DL symbol. As an example of the DL signal/channel, the CORESET may be included.

According to a proposed method, subcarriers in which the terminal receiving the DCI format x can receive a DL signal/channel even in an FL symbol may be derived.

Method D.4-1: A DL signal/channel may be received only when it is determined that all resources for receiving the DL signal/channel are valid.

FIG. 26 is a conceptual diagram illustrating an exemplary embodiment in which a CORESET is received.

Referring to FIG. 26, in FL symbols in which a CORESET is received, DL reception is allowed in some subcarriers, but DL reception is not allowed in some subcarriers. Therefore, the terminal may not receive the CORESET.

### HARQ-ACK Deferral

When the terminal transmits a HARQ-ACK for an SPS PDSCH, a time resource for transmitting an SPS PUCCH including the HARQ-ACK may also be indicated by an activating DCI and/or higher layer signaling. In a system operating in the TDD mode or a system operating in an unlicensed band, a resource of a PUCCH for transmitting a HARQ-ACK may not always be utilized. In the TDD mode, since an SPS PUCCH can be transmitted only in UL symbol(s), the terminal may not transmit the PUCCH in other symbols (i.e., DL symbol or FL symbol). In unlicensed band communication, if the terminal does not acquire a COT or does not receive a COT, the terminal may not transmit the PUCCH. In addition, the terminal may not transmit the PUCCH in symbols belonging to an idle period.

For convenience of description, a HARQ-ACK for an SPS PDSCH and/or a HARQ-ACK for a DCI for releasing an SPS may be referred to as an ‘SPS HARQ-ACK’.

In the case of the TDD mode, a slot pattern may be indicated to the terminal through RRC signaling or may be indicated through a DCI. The slot pattern may be indicated with a specific periodicity, and a pattern of DL symbol(s), UL symbol(s), and/or FL symbol(s) may be indicated to the terminal. Some of the FL symbols indicated by RRC signaling may be changed to or determined as DL symbol(s), UL symbol(s), or FL symbol(s) through a specific DCI (e.g., DCI format 2_0).

According to configuration or scheduling, the terminal may receive a DL signal/channel or transmit a UL signal/channel in a semi-static FL symbol. Alternatively, the terminal may not perform periodic reception or transmission in a semi-static FL symbol. For example, a symbol capable of receiving an SPS PDSCH may be a semi-static DL symbol. For example, a symbol capable of transmitting a PUCCH including an SPS HARQ-ACK may be limited to a semi-static UL symbol. However, since a UL signal/channel allocated by a DCI may be multiplexed in another UL signal/channel, the UL signal/channel allocated by the DCI may be transmitted even in a semi-static FL symbol.

When operating as frame-based equipment (FBE) in an unlicensed band, the terminal may not perform transmission in an idle period. Here, the terminal may derive the idle period based on a specific DCI (e.g., DCI format 2_0) or implicitly. For a fixed frame period (FFP) initiated by the terminal, the terminal may not perform transmission in an idle period. Similarly, for an FFP initiated by the base station, the base station may not perform transmission in an idle period.

The terminal or the base station wanting to transmit an SPS HARQ-ACK may not transmit an SPS PDSCH associated with the SPS HARQ-ACK or an SPS PUCCH including the SPS HARQ-ACK if the SPS PUCCH including the SPS HARQ-ACK is expected to be invalid. When the SPS PDSCH is not transmitted, the base station may dynamically schedule a PDSCH by transmitting a DCI to the terminal so that a valid PUCCH is transmitted. In order to perform dynamic scheduling of a PDSCH in an unlicensed band, the base station should also secure a COT or a COT should be shared to the base station. This is because, if the base station does not secure a COT or a COT is not shared to the base station, the base station cannot transmit the PDCCH.

(1) Case where an SPS HARQ-ACK is Deferred within a Valid Time

Depending on a periodicity of an SPS PDSCH, a periodicity of TDD slots, or a periodicity of an FFP, a timing of an SPS PUCCH may be changed to a specific timing or may be deferred. A time resource in which an SPS HARQ-ACK can be transmitted may be additionally allowed by the technical specification.

When the terminal fails to transmit an SPS HARQ-ACK, the terminal may transmit the SPS HARQ-ACK on the first PUSCH or PUCCH occurring later. That is, the SPS HARQ-ACK may be interpreted as being transmitted in a (sub) slot of the first PUSCH or PUCCH valid for the terminal. For example, the terminal may be indicated with one value of an offset for a (sub) slot in which an SPS PUCCH is transmitted. If the terminal cannot transmit the SPS PUCCH at a time indicated by the offset, the terminal may multiplex the SPS HARQ-ACK to be included in the SPS PUCCH in the first PUSCH or PUCCH after the time indicated by the offset.

In case of a time resource (i.e., feedback timing or slot offset) of the PUCCH for transmitting the HARQ-ACK, when the length of the subslot is additionally indicated to the terminal through RRC signaling, the subslot may be configured to have a different number (e.g., 2 or 7) of symbols from the indicated number of symbols. When the subslot is indicated, the feedback timing of the PUCCH may be interpreted in units of subslots, and when the subslots are not indicated, the feedback timing of the PUCCH may be interpreted in units of slots. For convenience of description, the slot may mean a slot having 14 symbols or a subslot having less than 14 symbols.

Traffic according to an SPS may have a limit of deferral time. Therefore, as mentioned above, even when the transmission of SPS HARQ-ACK is deferred so that the terminal transmits the SPS HARQ-ACK on the first PUSCH or PUCCH after the time indicated by the corresponding offset, the SPS HARQ-ACK should be transmitted only within the deferral time limit according to the SPS. To this end, the terminal may utilize k1offset indicated through RRC signaling.

When the SPS is activated/configured, the terminal may be indicated an offset for a slot for transmitting the HARQ-ACK. The offset for the slot for transmitting the HARQ-ACK may be referred to as k1. When k1offset is additionally indicated or configured, the terminal may transmit the SPS HARQ-ACK in (k1eff=k1+k1offset) slots from a UL slot to which the last symbol in which the SPS PDSCH is received belongs. Preferably, k1offset may have an independent value for each SPS configuration. k1eff should be maintained to be less than the maximum deferral time of the traffic according to the SPS. The largest value among k1offset may be referred to as k1offset, max, and may be preferably configured to the terminal through RRC signaling. It may be preferable that k1offset,max has a different value depending on the type of the traffic according to the SPS.

Method E.1-1: An SPS configuration including k1offset, max may be configured to the terminal.

The terminal may multiplex the SPS HARQ-ACK and other UCI types in the slot in which the PUCCH (or PUSCH) is to be transmitted. According to an indication (or configuration) of the base station, UCIs corresponding to different priorities (e.g., eMBB or URLLC) may be multiplexed.

### (2) Type1 HARQ Codebook Generation Method

There may be a deferred SPS HARQ-ACK according to a TDD slot pattern. In consideration of a deferred SPS HARQ-ACK, (non-deferred) SPS HARQ-ACK, and other UCIs, one PUCCH resource may be determined. When the terminal transmits a PUSCH, UCI to be transmitted in a corresponding PUCCH resource may be multiplexed in the PUSCH. In this process, some UCI(s) may be dropped.

A size of a type1 HARQ codebook may be derived from configuration parameters configured through RRC signaling. A time resource for transmitting a PDSCH may be indicated to the terminal by K0 and a TDRA index for a TDRA table. Here, K0 denotes an interval between a slot in which a DCI for scheduling the PDSCH is received and a slot in which the PDSCH is received. Also, K1 denotes an interval between the slot in which corresponding PDSCH is received and a slot (or subslot) in which a HARQ-ACK for the PDSCH is transmitted.

In a process of generating the type1 HARQ codebook, a position of each HARQ-ACK in the type1 HARQ codebook may be determined in consideration of K1 and the TDRA index. This position determination may be applied to both a dynamically scheduled HARQ-ACK and an SPS HARQ-ACK. However, the preconfigured K1 and TDRA index may not be applied to the deferred SPS HARQ-ACK. Therefore, specific methods for generating the type1 HARQ codebook should be considered.

The deferred HARQ-ACK bits may constitute a deferred HARQ-ACK bit stream in the order in which the corresponding SPS PDSCHs are received. In a proposed method, the deferred HARQ-ACK bit stream may be additionally concatenated to the conventional HARQ codebook.

Method E.2-1: A deferred HARQ-ACK bit stream composed of only deferred HARQ-ACK bits is separately generated, and the bit stream may be concatenated to a HARQ-ACK codebook according to the existing technical specification.

When a plurality of serving cells are configured, a deferred HARQ codebook composed of only deferred HARQ-ACK bits of all the configured multiple serving cells may be generated. After a HARQ codebook according to the existing technical specification is separately generated, the deferred HARQ codebook and the conventional HARQ codebook may be concatenated to generate one HARQ codebook. Thereafter, the corresponding HARQ codebook may be coded and modulated, and transmitted on a UL channel.

In another proposed method, deferred HARQ-ACK bits and non-deferred HARQ-ACK bits may be concatenated in a HARQ codebook (or HARQ sub-codebook, HARQ-ACK bit stream) generated for each serving cell. This method may mean that a HARQ codebook is newly generated in a slot in which the deferred HARQ-ACK bits are to be transmitted. The deferred HARQ-ACK bits and non-deferred HARQ-ACK bits may not be distinguished and may be regarded equally as SPS HARQ-ACKs.

The SPS HARQ-ACK bits may be included in the HARQ codebook in a target slot, and it may be preferable to reflect values of the most recent HARQ-ACK bits for the corresponding HARQ processes. This may be explained in more detail in the following description.

Method E.2-2: For a given serving cell, deferred SPS HARQ-ACK bit(s) may be arranged in the order in which the corresponding SPS PDSCHs are received to generate the deferred HARQ-ACK bit stream, and the generated deferred HARQ-ACK bit stream may be concatenated with a (non-deferred) HARQ-ACK bit stream generated using the existing technical specification.

When a plurality of serving cells are configured, a deferred HARQ-ACK bit stream and a non-deferred HARQ-ACK bit stream of each serving cell may be concatenated, and these bit streams may be concatenated in the order of indexes of the corresponding serving cells, so that one HARQ codebook may be generated. Thereafter, the HARQ codebook may be coded and modulated, and transmitted on a UL channel.

A maximum deferral time allowed for a deferred HARQ-ACK may be indicated to the terminal. For example, an SPS configuration may include k1offset (or k1offset,max). In this case, in the various methods (e.g., Method E.2-1 and Method E.2-2) of generating the type1 HARQ codebook, it may be preferable that the terminal performs an additional operation for determining validity of a specific SPS HARQ-ACK.

Method E.2-3: A time window may be indicated to the terminal, and the terminal may transmit (i.e., defer) an SPS HARQ-ACK in a subsequent UL channel within the corresponding time window. If the terminal does not multiplex the SPS HARQ-ACK or multiplexes the SPS HARQ-ACK outside the corresponding time window, it may be regarded as NACK. If the SPS HARQ-ACK is not multiplexed, the size of the HARQ codebook may be reduced.

The time window (or its length) may be indicated to the terminal by higher layer signaling, and the terminal may know a time during which the SPS HARQ-ACK is valid based on the indicated time window (or its length). Therefore, since the terminal does not need to transmit the HARQ-ACK outside the time window, the terminal may not perform a procedure for including the SPS HARQ-ACK for the corresponding SPS-configIndex (or SPS configuration) in a subsequent UL channel.

A case in which the terminal receives an SPS PDSCH, an SPS release, or a PDSCH allocated by a DCI may be considered. According to the existing technical specification, when only one serving cell is configured to the terminal, the number M_{A,c} of PDSCH(s) or SPS release(s) received by the terminal is 1, and a code block group (CBG)-based transmission is configured for the terminal, but a field for a CBG is not configured in the DCI, the terminal may generate the type 1 HARQ codebook only with HARQ-ACK(s) for the corresponding TB or SPS release. In addition, when one or more serving cells are configured to the terminal, M_{A,c} is equal to or greater than 1, and a CBG-based transmission is configured to the terminal, but scheduling is performed by a DCI format 1_0, the terminal may generate the type1 HARQ codebook by repeating the HARQ-ACK for the corresponding TB or SPS release a predetermined number of times (i.e., the maximum number of CBGs that are indicated to the terminal by RRC signaling and can configure one TB).

Considering the deferred HARQ-ACK, even if the size of the type1 HARQ codebook derived based on the existing technical specification is 1 (M_{A,c}), the amount of deferred HARQ-ACK bits may be additionally considered. In this case, the terminal may generate the type1 HARQ codebook in consideration of 1-bit HARQ-ACK and the deferred HARQ-ACK bit(s). Method E.2-4 below may be easily extended and applied even when M_{A,c} is 1 or more.

Method E.2-4: When the type1 HARQ codebook and CBG-based transmission are configured, but information on a CBG is not included in the DCI, the type1 HARQ codebook may be generated by additionally considering the deferred HARQ-ACK bit(s).

When a HARQ codebook including the SPS HARQ-ACK(s) is generated, the SPS HARQ-ACK(s) may be concatenated to a bit stream of dynamically scheduled HARQ-ACK(s) having the same priority. In this case, the bit stream of the dynamically scheduled HARQ-ACK(s) may be arranged first, and the bit stream of the SPS HARQ-ACK(s) may be arranged later. When the bit stream of the dynamically scheduled HARQ-ACK(s) does not exist, only the bit stream of the SPS HARQ-ACK(s) may be arranged.

When HARQ-ACK bit streams having two or more priorities are given, after each of the HARQ-ACK bit streams having the same priority may be generated as an independent HARQ codebook, the generated HARQ codebooks may be concatenated. The dynamically scheduled HARQ-ACK(s) may follow a priority index given by a corresponding scheduling DCI, and the SPS HARQ-ACK(s) may follow a priority index given through RRC signaling.

When the amount of UCI is 11 bits or less, an Equation for deriving a power allocated to a UL channel for transmitting the corresponding UCI is considered. According to the existing technical specification, the number of HARQ-ACK bit(s) may be derived based on the number of received PDSCH(s). Specifically, for a given serving cell(s), the number of PDSCHs received by the terminal (or configured to the terminal) may be based on the number of TBs or the number of CBGs. The number of HARQ-ACK bits may be determined based on the number of TBs or the number of CBGs. The amount of UCI may be determined by additionally adding the amount of SR and the amount of CSI.

Considering the deferred HARQ-ACK bit(s), the number of deferred HARQ-ACK bit(s) may be further added to the number of HARQ-ACK bit(s).

Method E.2-5: The amount of HARQ-ACK bits calculated when the terminal derives the transmission power of the UL channel may be determined by including the number of deferred HARQ-ACK(s) as well as the number of PDSCHs (or the number of TBs or CBGs) received by the terminal or configured to the terminal.

### (3) Type2 HARQ Codebook Generation Method

The terminal may generate a HARQ codebook based on the number of received PDSCHs. To this end, the terminal may derive the size of the HARQ codebook based on the number of DCIs corresponding to the received PDSCHs. The scheduling DCI may include a C-DAI field or a C-DAI field and a T-DAI field. According to the existing technical specification, the size of the type2 HARQ codebook may be changed to a size further considering HARQ-ACK bit(s) for SPS PDSCH(s) in addition to the (L) HARQ-ACK bits according to the dynamically scheduled PDSCH(s). For example, when the terminal receives only one SPS PDSCH, only one HARQ-ACK bit corresponding to the corresponding SPS PDSCH may be added to the type2 HARQ codebook, and the type2 HARQ codebook may include (L+1) bits. Here, when two or more SPS PDSCHs are activated for the terminal, an SPS HARQ codebook (e.g., SPS HARQ codebook having L1 bits) that follows a predetermined rule may be generated, and may be concatenated with the L bits described above.

Even when only one SPS is activated for the terminal, deferred HARQ-ACK bit(s) may be generated. In this case, a method in which only the deferred HARQ-ACK bit(s) are added to the type2 HARQ codebook or a method in which a separate SPS HARQ codebook including the deferred HARQ-ACK bit(s) is additionally generated may be considered.

Method E.3-1: The type2 HARQ codebook in which deferred HARQ-ACK(s) are concatenated with the L bits may be transmitted.

Here, when an SPS PDSCH is received, deferred HARQ-ACK(s) of 1 bit (or 2 bits depending on the number of codewords, or 2 bits or more depending on the number of CBGs) may be generated.

Method E.3-2: The SPS deferred HARQ codebook may be generated, and the generated SPS deferred HARQ codebook may be concatenated with the L bits and transmitted.

When the amount of UCI is 11 bits or less, an equation for deriving a transmission power allocated to a UL channel may be considered. According to the existing technical specification, the number of HARQ-ACK bits may be determined based on the number of received PDSCHs. Specifically, for a given serving cell, the number of TBs or the number of CBGs may be determined based on the C-DAI (and the value of T-DAI) received by the terminal and the number of PDSCHs received by the terminal. A sum of the number of TBs or the number of CBGs may be determined as the number of HARQ-ACK bits, and the amount of UCI may be determined by additionally considering the amount of SR and the amount of CSI. Here, from a value derived based on the C-DAI (and T-DAI), the number of discontinuous transmissions (DTXs) occurring in the terminal may be estimated. Here, the number of PDSCHs may include both the number of PDSCHs allocated through DCIs and the number of SPS PDSCHs.

In the proposed equation deriving the number of HARQ-ACK(s) considering the number of deferred HARQ-ACK bit(s), the number of deferred HARQ-ACK bit(s) may be included in the number of HARQ-ACK bit(s).

Method E.3-3: The amount of HARQ-ACK bits calculated when the terminal derives the transmission power of the UL channel may be determined considering the C-DAI (and T-DAI) received by the terminal, the number of PDSCHs received by the terminal (the number of TBs or CBGs), and the number of deferred HARQ-ACK(s).

In the process of generating the type2 HARQ codebook, when HARQ-ACKs or UCIs and TBs having two or more priorities are related, if the DCI includes a DAI to schedule the PDSCH or PUSCH, a separate DAI for each priority may be indicated to the terminal. For example, when two priorities corresponding to URLLC traffic and eMBB traffic are indicated to the terminal, each of C-DAI and T-DAI may be included in the DCI as a double-sized field.

### (4) HARQ Codebook Generation Method in Case of 2 or More Deferrals

The terminal may be configured to perform deferral of SPS HARQ-ACK(s) through RRC signaling. In this case, if the terminal is indicated to transmit a HARQ-ACK in a first slot, but fails to transmit the HARQ-ACK in the first slot for various reasons, the terminal may transmit the HARQ-ACK in a second slot. Here, the first to second slots may be interpreted as slots or subslots.

The various reasons described above may include a case of intending to transmit a PUCCH (and/or PUSCH) in a symbol temporally overlapping a symbol indicated as a DL symbol according to a slot pattern configured through RRC signaling in the TDD mode, a case of intending to transmit a PUCCH (and/or PUSCH) temporally overlapping an SS/PBCH block configured through RRC signaling, or a case of intending to transmit a PUCCH (and/or PUSCH) temporally overlapping a CORSET associated with a type0-PDCCH CSS set.

The first slot may be derived by applying a (sub) slot offset to a (mini-) slot in which an SPS PDSCH corresponding to the HARQ-ACK is received. The second slot may be a slot after the first slot, and may refer to the earliest (sub) slot in time among slots in which the HARQ-ACK can be transmitted. In the PUCCH (or PUSCH) transmitted in the second slot, not only the HARQ-ACK but also another SPS HARQ-ACK and/or a HARQ-ACK for a dynamically scheduled PDSCH may be included.

A case may be considered in which there are two or more deferred HARQ-ACK bits, and the terminal intends to transmit the deferred HARQ-ACK bits in a certain second (sub) slot. For a HARQ codebook 0 that the terminal intends to initially transmit in the corresponding (sub) slot, a HARQ codebook 1 deferred once and a HARQ codebook 2 deferred twice may be considered as a transmission target in concatenation with the HARQ codebook 0.

According to a proposed method, when the terminal intends to transmit only one of the HARQ codebook 1 and the HARQ codebook 2, the HARQ codebook 1 or HARQ codebook 2 may be concatenated with the HARQ codebook 0. Since a PUCCH resource is not valid in a (sub) slot in which the terminal initially intends to transmit the HARQ codebook 2, a subsequent (sub) slot may be considered. In the subsequent (sub) slot, the HARQ codebook 1 may be initially transmitted, and it may be identified whether the HARQ codebook 1 can be transmitted on a PUCCH (or PUSCH) as being concatenated with the HARQ codebook 2. Here, since the PUCCH (or PUSCH) in which the HARQ codebook 2 and the HARQ codebook 1 are concatenated is not valid, a case in which a subsequent (sub) slot is considered will be described.

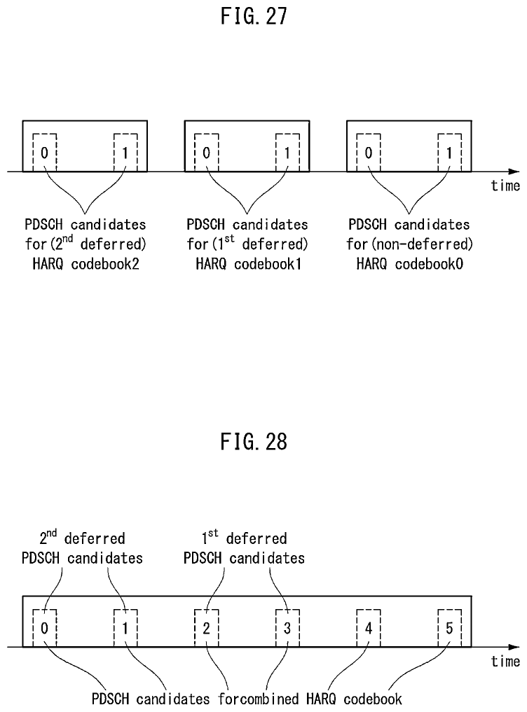

FIG. 27 is a conceptual diagram illustrating a first exemplary embodiment in which an SPS HARQ codebook is generated.

Referring to FIG. 27, when a PUCCH (or PUSCH) is transmitted, the HARQ codebook 0, the HARQ codebook 1, and the HARQ codebook 2 may be concatenated. In each HARQ codebook, HARQ-ACKs may be arranged in a temporal order of corresponding PDSCH candidates.

A case in which the HARQ codebook 0 is to be initially transmitted in a (sub) slot and the HARQ codebook 1 and the HARQ codebook 2 are concatenated to the HARQ codebook 0 may be considered. In this case, an order in which the HARQ codebook 1 and the HARQ codebook 2 are concatenated should be determined.

In an exemplary embodiment, a HARQ codebook concatenated with the HARQ codebook 0 may be the HARQ codebook 1 deferred once. Thereafter, the HARQ codebook 2 deferred twice may be concatenated.

Method E.4-1: A temporally later HARQ codebook may be arranged first, and a temporally earlier HARQ codebook may be arranged thereafter.

When applying Method E.4-1 to the above-described case, the HARQ codebook 2 may be appended to the HARQ codebook 1. Accordingly, the HARQ codebook 0, the HARQ codebook 1, and the HARQ codebook 2 may be sequentially arranged to configure a bit stream of the HARQ-ACKs.

In another exemplary embodiment, the HARQ codebooks concatenated with the HARQ codebook 0 may be arranged differently from Method E.4-1. As being appended to the HARQ codebook 0, a bit stream of HARQ-ACKs may be generated in an order of the HARQ codebook 2 and the HARQ codebook 1.

Method E.4-2: A temporally earlier HARQ codebook may be arranged first, and a temporally later HARQ codebook may be arranged thereafter.

When applying Method E.4-2 to the above-described case, the HARQ codebook 2, the HARQ codebook 1, and the HARQ codebook 0 may be sequentially arranged to configure a bit stream of the HARQ-ACKs.

Meanwhile, a HARQ process number (HPN) corresponding to each SPS PDSCH may be determined based on the equation defined in the technical specification. The HPN corresponding to each SPS PDSCH may be determined according to a time resource in which each SPS PDSCH is received. Depending on a configuration of the base station, an HPN offset may be indicated to the terminal through RRC signaling.

When the terminal receives SPS PDSCHs, SPS PDSCHs belonging to different SPS configurations may have the same HPN, or different SPS PDSCHs belonging to the same SPS configuration may have the same HPN. In general, the base station may configure appropriate HPN offsets to the terminal so that the HPNs do not collide with each other. However, when transmission of HARQ-ACK(s) is deferred in the TDD mode or an unlicensed band, different SPS PDSCHs may unintentionally use the same HPN.

Method E.4-3: For different PDSCHs using the same HPN, a HARQ-ACK for an SPS PDSCH received earlier in time may be replaced with a HARQ-ACK for a PDSCH received later in time.

Here, the PDSCH received later may be another SPS PDSCH of the same SPS configuration as the SPS PDSCH received earlier, may be an SPS PDSCH of another SPS configuration, or may be a PDSCH dynamically scheduled by a DCI.

A PDSCH dynamically scheduled by a DCI may also be indicated to have an HPN occupied by a certain SPS PDSCH. This case may occur before an SPS HARQ-ACK is reported to the base station. A HARQ-ACK derived for the PDSCH dynamically scheduled by the DCI may update the existing HARQ-ACK of the corresponding HPN. However, since the DCI explicitly includes the HPN, the base station may not need to schedule a PDSCH by using the HPN for the HARQ-ACK that has not been reported yet. Therefore, when applying Method E.4-3, a HPN collision between only SPS PDSCHs may be considered.

At a time when the terminal has not yet reported the HARQ-ACK to the base station for the HPN occupied by the SPS, if the terminal dynamically schedules a PDSCH by using the HPN so that the SPS HARQ-ACK is updated to a DS HARQ-ACK, the SPS HARQ-ACK may no longer be considered as an SPS HARQ-ACK. In an example, when generating an SPS HARQ codebook composed of SPS HARQ-ACK(s), the HARQ-ACK for the corresponding HPN may not be considered. Here, the HARQ-ACK may be replaced with a new value (i.e., a HARQ-ACK derived from the most recently received PDSCH in the corresponding HPN). The size of the SPS HARQ codebook may be maintained by including the HARQ-ACK for the corresponding HPN in the SPS HARQ codebook, or may be reduced by not considering the HARQ-ACK for the corresponding HPN and omitting the HARQ-ACK.

One HPN may be utilized by two or more SPS PDSCHs. As an example, the corresponding HPN may be utilized by both an SPS PDSCH candidate1 belonging to the HARQ codebook 1 and an SPS PDSCH candidate0 belonging to the HARQ codebook 0. When Method E.4-3 is applied, since the SPS PDSCH candidate0 was received later in time, the HARQ-ACK corresponding to the HPN may be derived from the SPS PDSCH candidate0. Therefore, if Method E.4-3 is applied, only the HARQ-ACK may be updated while maintaining the sizes of HARQ codebooks.

According to another method, the terminal may not report the HARQ-ACK for the SPS PDSCH candidate1 to the base station. The above-described scheme may be generalized and applied to a plurality of HARQ codebooks (e.g., codebook i (i=1, 2, 3, . . . )).

Method E.4-4: When generating a deferred HARQ codebook, a HARQ-ACK for a specific HPN (i.e., the HPN shared with another PDSCH and the HARQ-ACK therefor is replaced with a new value) may not be included.

By not including the HARQ-ACK for the corresponding HPN, the size of the HARQ codebook i including the corresponding HPN may be reduced than the size of the HARQ codebook generated before being deferred.

On the other hand, the HARQ codebooks generated in units of the deferred HARQ codebook may not consider a predetermined arrangement order. That is, a method in which the deferred HARQ-ACK bits and the non-deferred HARQ-ACK bits are not distinguished from each other, or a method in which the deferred HARQ-ACK bits are not distinguished by the number of deferrals may be considered.

That is, if the HARQ-ACK is deferred, one deferred HARQ codebook may be generated. Methods E.4-1 and E.4-2 propose an order in which HARQ sub-codebooks are generated according to the number of deferrals, respectively, and they are arranged through a predetermined rule. In this method, the terminal may store each HARQ sub-codebook, and may generate one HARQ codebook by concatenating the HARQ sub-codebooks in a target slot capable of transmitting a PUCCH (or PUSCH). In this case, values of HARQ-ACKs belonging to the HARQ sub-codebook may have to be stored in the terminal. In this case, it may not be preferable because a storage device of the terminal is consumed. Therefore, in another proposed method, the terminal may generate a HARQ codebook in the target slot but may not store the values of HARQ-ACKs, and may generate a deferred HARQ codebook in which deferred HARQ-ACKs are not distinguished by the number of deferrals.

Method E.4-5: When generating the deferred HARQ codebook, the terminal may arrange the deferred HARQ-ACK bits in one deferred HARQ codebook.

If non-deferred HARQ-ACK bit(s) are present, it may not be determined whether HARQ-ACK bit(s) are deferred HARQ-ACK bit(s) or non-deferred HARQ-ACK bit(s), and all the HARQ-ACK(s) may be regarded as being generated as the SPS HARQ codebook.

Hereinafter, a method for the terminal to generate the SPS HARQ codebook will be described in more detail. The proposed Method E.4-5 may be described by modifying this method.

In the SPS HARQ codebook, HARQ-ACKs may be arranged according to a temporal order in which the corresponding SPS PDSCHs are received, then arranged according to an order of the corresponding SPS configuration indexes, and then arranged in an order of the corresponding serving cell indexes.

According to the existing technical specification, (sub) slot offsets applied to PDSCH-to-HARQ-feedback may be configured to the terminal through RRC signaling. For a (sub) slot in which the terminal intends to transmit a PUCCH, candidate slots in which an SPS PDSCH can be received may be derived. The number of candidate slots may be limited to Nc in a serving cell c.

Accordingly, when the SPS HARQ codebook is generated, it may correspond to the HARQ codebook 1 and the HARQ codebook 2 in Methods E.4-1 and E.4-2. In Method E.4-5, Nc may be further extended to be increased by a deferred window. When deferred once, the value of Nc may be interpreted as a value that is doubled by adding a non-deferred Nc, and when deferred twice, the value of Nc may be interpreted as a value that is increased by 3 times.

FIG. 28 is a conceptual diagram illustrating a second exemplary embodiment in which an SPS HARQ codebook is generated.

Referring to FIG. 28, when a PUCCH (or PUSCH) is transmitted, a HARQ codebook that does not consider the number of deferrals may be generated. Although PDSCH candidates are arranged in order, the value of Nc may be regarded as 6. On the other hand, in Methods E.4-1 and E.4-2, it may be interpreted as in FIG. 27, and the value of Nc may be regarded as 2.

(5) HARQ Codebook Generation Method when Supporting Different Types of Traffic

When transmitting a PUCCH (or PUSCH), only UCI(s) corresponding to the same priority index may be transmitted on the PUCCH (or PUSCH). Alternatively, UCIs corresponding to different priority indices may also be transmitted on the PUCCH (or PUSCH). The priority index may be indicated to the terminal through RRC signaling or a DCI. The UCIs corresponding to the same priority index may belong to the same codeword. Alternatively, the UCIs corresponding to the same priority index may belong to different codewords according to UCI types. Alternatively, the UCIs corresponding to different priority indexes may belong to different codewords.

A priority index of an SPS HARQ-ACK may be indicated to the terminal through RRC signaling. In this case, a deferred SPS HARQ-ACK and an UCI to be transmitted in a target slot may have the same priority index or different priority indexes.

An operation in which an SPS HARQ-ACK cannot be transmitted in an initial slot, and deferred to a target slot has been described above. This may be applied when the deferred HARQ-ACK and the UCI have the same priority index. Even if not, the contents described above may be extended and applied.

Method E.5-1: The deferred HARQ-ACK(s) may be concatenated with the HARQ codebook having the same priority index.

The deferred HARQ-ACK(s) may be concatenated with UCI having the same priority index. If the UCI includes a HARQ codebook, the deferred HARQ-ACK(s) (or, deferred HARQ codebook) may be concatenated with the corresponding UCI. If the UCI does not include a HARQ codebook, only the deferred HARQ codebook may be considered as HARQ-ACK(s). Thereafter, if the UCI includes a CSI part 1 and/or CG-UCI, they may concatenated and regarded as a single unit of information bits, and may be processed as the same codeword through an encoding procedure.

Additionally, if there are UCIs corresponding to priority indexes having different values, the UCIs having different priority indexes may be processed as different codewords through different encoding procedures.

The SPS activated for the terminal may have several priority indexes. An SPS HARQ codebook corresponding to a priority index 0 and an SPS HARQ codebook corresponding to a priority index 1 may be generated independently of each other. Thereafter, a group common DCI (e.g., DCI format 2_0 or format 2_4) may be applied. Therefore, a deferred SPS HARQ codebook may be considered for each priority index.

(6) HARQ Codebook Generation Method when Sidelink is Supported

A HARQ-ACK is not necessarily generated only for a PDSCH. When the terminal performing sidelink communication operates in a mode 1 in which the base station controls resource allocation, a decoding result of a PSSCH transmitted by the terminal may be received on a PSFCH. Alternatively, even without a separate PSFCH, the terminal may regard the decoding result of the PSSCH as ACK or NACK according to the technical specification.

In this case, a HARQ codebook for sidelink communication (i.e., SL HARQ codebook) and a HARQ codebook for PDSCH(s) (i.e., DL HARQ codebook) may not be concatenated with each other according to the technical specification. The base station should properly adjust slots in which the terminal transmits the SL HARQ codebook and/or DL HARQ codebook, so that PUCCH resources of the SL HARQ codebook and the DL HARQ codebook do not overlap in time.

A priority index of the SL HARQ codebook may be interpreted as 0 or 1. A priority of a PSSCH may be a priority given in the sidelink communication and may be independent of the priority index. If the priority of the PSSCH exceeds a certain threshold, the priority index of the SL HARQ codebook may be considered to have a high priority, and if the priority of the PSSCH does not exceed the certain threshold, the priority index of the SL HARQ codebook may be considered to have a low priority. Here, the threshold may be configured to the terminal through RRC signaling. The priority of the SL HARQ codebook may be determined as a result of comparing the highest priority among the priorities of the PSSCH with the threshold.

Method E.6-1: Concatenation between the DL HARQ codebook and the SL HARQ codebook may be allowed.

In order to transmit an SPS deferred HARQ codebook, the terminal may determine whether the SPS deferred HARQ codebook can be transmitted in a slot in which the terminal intends to transmit a PUCCH or in the same PUCCH resource (or PUSCH overlapping in time with the same PUCCH resource) of a slot after the slot. That is, the terminal performs a procedure to find a target slot. When Method E.6-1 is applied, the SPS deferred HARQ codebook may be concatenated with the DL HARQ codebook, and the SL HARQ codebook may be concatenated thereafter.

However, according to a technical specification, the terminal may assume that the DL HARQ codebook and the SL HARQ codebook are not concatenated with each other. The base station may need to perform scheduling appropriately so that a case where the DL HARQ codebook and the SL HARQ codebook are concatenated does not occur. However, when a plurality of SPS PDSCHs are activated and a plurality of CG PSSCHs are activated, the above-described appropriate scheduling may be difficult. In this case, Method E.6-2 may be applied, and more specifically, Method E.6-3 and Method E.6-4 may be considered.

Method E.6-2: Concatenation of the DL HARQ codebook and the SL HARQ codebook may not be allowed.

Method E.6-3: In Method E.6-2, a procedure of not determining that the corresponding (sub) slot is valid, and determining whether a PUCCH resource (or, PUSCH overlapping in time with the PUCCH resource) including the SPS deferred HARQ-AKC(s) can be transmitted in a subsequent (sub) slot may be performed.

The terminal should be able to additionally determine whether the HARQ codebook includes the DL HARQ-ACK or the SL HARQ-ACK without determining whether the corresponding time resource is valid or invalid only with the PUCCH resource. Since this is equivalent to an operation of determining whether the HARQ-ACK corresponds to a PDSCH or a PSSCH, various methods may be considered.

As an example, the terminal may determine by using an RNTI. If scrambled with a C-RNTI/MCS-C-RNTI/CS-RNTI, it may be classified as the DL HARQ-ACK, and if scrambled with an SL-CS-RNTI, it may be classified as the SL HARQ-ACK.

If the SPS deferred HARQ-ACKs cannot be multiplexed, the terminal may consider that the target slot has not yet been found, and thus the terminal may perform the procedure for finding the target slot again.

Method E.6-4: In Method E.6-2, the SPS deferred HARQ-ACK(s) may be considered not to be transmitted, and the additional procedure for finding the target slot may be stopped.

If the terminal determines that the PUCCH or PUSCH in which the deferred HARQ-ACK bit stream and another HARQ-ACK bit stream are multiplexed is not transmitted in a valid resource, the terminal may drop the corresponding deferred HARQ codebook. Thereafter, the terminal may not determine validity of the deferred HARQ-ACK also in other (sub) slots.

The above-proposed Methods E.6-1 to E.6-4 may be applied to the case where the SL HARQ codebook and the DL HARQ codebook have the same priority. If it is determined that the SL HARQ codebook and the DL HARQ have different priorities, only the SL HARQ codebook or the DL HARQ codebook having a higher priority may be selected and transmitted. If the SL HARQ codebook is selected and transmitted, the procedure for additionally finding the target slot for the deferred HARQ-ACK bit stream included in the DL HARQ codebook may be stopped.

(7) HARQ Codebook Generation Method when Multicast is Supported

For a case when the terminal supports multicast, the above-described methods applied to sidelink may be easily extended. When the terminal supports both multicast and unicast, a multicast HARQ codebook and a unicast HARQ codebook may be concatenated with each other. Here, the unicast HARQ codebook may refer to the general HARQ codebook described so far, and the multicast HARQ codebook may refer to a HARQ codebook including HARQ-ACKs generated by receiving a multicast PDSCH. The unicast HARQ codebook and the multicast HARQ codebook may be distinguished by a DCI allocating the PDSCH corresponding to the HARQ-ACK or an RNTI for scrambling the PDSCH corresponding to the HARQ-ACK. More specifically, the following cases may be considered.

As a first case, an SPS deferred HARQ codebook may be considered in a (sub) slot in which the unicast HARQ codebook and the multicast HARQ codebook are transmitted.

Method E.7-1: The SPS deferred HARQ codebook may be concatenated with the unicast HARQ codebook, and then concatenated with the multicast HARQ codebook again.

As a second case, a deferred HARQ codebook may be considered in a (sub) slot in which only the multicast HARQ codebook is transmitted.

Method E.7-2: Concatenation of the SPS deferred HARQ codebook and the multicast HARQ codebook may be allowed.

In the proposed methods, in order to be concatenated with the SPS deferred HARQ codebook and the unicast HARQ codebook or the multicast HARQ codebook, it may be limited to a case having the same priority index.

(8) HARQ Codebook Generation Method when a CORESET Pool is Supported

A CORESET pool index may be configured to the terminal. When multi-point transmission and reception is performed, the CORESET pool index may be interpreted as corresponding to a TRP. CORESETs having the same CORESET pool index may be interpreted as being received from the same TRP, but TCI states of these CORESETs may be different. When an SPS is configured, an activating DCI may be received in one CORESET, and a CORESET pool index for the CORSET may be given. For convenience of description, consider a case where there are two CORESET pool indexes, and may be referred to as a first CORESET and a second CORESET, respectively.

The terminal may be configured through RRC signaling to transmit HARQ-ACKs for different TRPs on one PUCCH (or PUSCH). When the terminal is configured to transmit HARQ-ACKs for different TRPs on one PUCCH (or PUSCH), the terminal should perform a procedure using CORSET pool indexes to generate a HARQ codebook.

A method of generating a type1 HARQ codebook is considered.

If a serving cell has the first CORESET, the corresponding serving cell may belong to a set S0 of serving cells, and if a serving cell has the second CORESET, the corresponding serving cell may belong to a set S1 of serving cells. For example, there may be a serving cell belonging to both S0 and S1, and there may be a serving cell belonging to only one. A type1 HARQ codebook may be generated for each of the sets S0 and S1, and the generated type1 HARQ codebooks may be concatenated with each other to generate one HARQ codebook.

When an SPS is activated, the CORESET pool index and the set S (50 or S1) may be determined based on the CORESET in which the activating DCI is detected. Thereafter, when a HARQ-ACK occurs for a PDSCH received without a separate DCI, the CORESET pool index and the set S may be determined based on the CORESET in which the activating DCI is detected. When the SPS is deactivated, a HARQ-ACK for an deactivating DCI may be transmitted, and the CORESET pool index and the set S may be determined based on the CORESET in which the deactivating DCI is detected. Alternatively, the CORESET pool index and the set S of the HARQ-ACK for the deactivating DCI may be determined based on the CORESET in which the activating DCI is detected. Alternatively, the CORESET pool index may not be configured for the activating DCI and the deactivating DCI related to the SPS. In this case, the HARQ-ACK for the PDSCH received without the activating DCI, deactivating DCI, and separate DCI may be regarded as having a CORESET pool index of 0 and corresponding to the set S0.

Method E.8-1: The deferred HARQ-ACK bit(s) may be concatenated with the type1 HARQ codebook in the serving cell set (i.e., set 50 or S1) including the corresponding SPS.

When a plurality of SPS deferred HARQ-ACK bits are considered, if the SPS deferred HARQ-ACK bits correspond to different serving cell sets, the corresponding SPS deferred HARQ-ACK bits may be concatenated to the type1 HARQ codebook at different positions.

A method of generating a type 2 HARQ codebook is considered.

In one serving cell, only the first CORESET may be configured or both the first CORESET and the second CORESET may be configured. When both the first CORESET and the second CORESET are configured, a type2 HARQ codebook for a given serving cell may be generated for the first CORESET, and then a type2 HARQ codebook for the second CORESET may be generated so that they are concatenated. Accordingly, a procedure for generating two type2 HARQ codebooks (i.e., arrangement of HARQ-ACK bits according to a reception order of DCIs) may be performed for one serving cell. Thereafter, the same procedure may be repeated for another serving cell to generate one HARQ codebook.

When an SPS is considered, the type2 HARQ codebook may be generated irrespective of the CORESET pool index to which the CORESET in which the DCI (activating DCI and/or deactivating DCI) related to the SPS is detected belongs, and concatenated with a type2 HARQ codebook comprised of HARQ-ACKs excluding the SPS (Method E.8-2). Alternatively, the type2 HARQ codebook may be generated according to the CORESET pool index to which the CORESET in which the DCI related to the SPS is detected, concatenated with a type2 HARQ codebook of the same CORESET pool index, and then concatenated with a type2 HARQ codebook having a different CORESET pool index (Method E.8-3).

Method E.8-2: When an SPS is considered, the SPS HARQ codebook may be generated separately from the type2 HARQ codebook, and may be concatenated with each other.

For the SPS, the SPS HARQ codebook may be generated regardless of the CORESET pool index.

However, the type2 HARQ codebook may be generated based on the CORESET in which the activating DCI is detected. When the SPS is deactivated, the type2 HARQ codebook including the HARQ-ACK for the deactivating DCI may be generated based on the CORESET in which the deactivating DCI is detected. Alternatively, the type2 HARQ codebook including the HARQ-ACK for the deactivating DCI may be generated based on the CORESET in which the activating DCI is detected.

Method E.8-3: The deferred HARQ-ACK bit(s) may be concatenated with the type2 HARQ codebook for the CORESET pool index (i.e., first CORESET or second CORESET) in which the DCI for the corresponding SPS is detected.

When a plurality of deferred HARQ-ACK bits are considered for the same SPS configuration index or when deferred HARQ-ACK bits are considered for different SPS configuration indexes, if the CORESET pool indexes are different, they may be concatenated with different type2 HARQ codebooks.

(9) HARQ Codebook Generation Method when a BWP is Switched

When a BWP is switched, the terminal may not perform DL reception or UL transmission in a part of a time during which the BWP is being switched. This method may also be applied when generating a HARQ codebook.

When the existing technical specification is followed, when a type1 HARQ codebook is generated while a BWP is switched, the type1 HARQ codebook may not include a HARQ-ACK for a specific PDSCH. That is, a DL (sub) slot in which the switching of the BWP is indicated should not occur earlier than a UL (sub) slot in which the type1 HARQ codebook is to be transmitted. In addition, the corresponding UL (sub) slot may not include a HARQ-ACK for a PDSCH candidate preceding the DL (sub) slot in which the switching of the BWP is indicated. Here, the BWP may mean both a DL BWP of a serving cell in which a PDSCH is received and a UL BWP of the serving cell in which a PUCCH is transmitted.

The UL (sub) slot may be denoted by n_{U}, an index of a DL (sub) slot belonging to the UL (sub) slot may be denoted by n_{D}, a subcarrier spacing of the DL BWP may be denoted by μ_{DL}, a subcarrier spacing of the UL BWP may be denoted by μ_{UL}, a PDSCH-HARQ slot offset to be considered may be denoted by K₁.

Here, for convenience of description, a case 1 refers to a case in which n_{U} is the same as or starts later than a DL slot for switching a DL BWP of a considered serving cell c. A case 2 refers to a case in which n_{U} is the same as or starts later than a DL slot for switching a UL BWP of a serving cell (i.e., PCell, PUCCH SCell, or SPCell) to which a PUCCH is to be transmitted. A case 3 refers to a case in which reception of a PDSCH candidate is earlier when comparing the PDSCH candidate and a DL slot in which switching of a BWP (DL BWP or UL BWP) is indicated by reflecting a difference between subcarrier spacings. If the case 3 is expressed by an equation, the slot in which the PDSCH candidate is received may be determined by n_{D}+ [(n_{U}−K₁)·2^{μ}^{_{DL}}^{-μ}^{_{UL}}].

According to the conventional method, when case 1 or case 2 is considered together with case 3, np may be increased by 1. Otherwise, an additional procedure for including the HARQ-ACK in the HARQ codebook may be performed.

Meanwhile, when generating a type2 HARQ codebook, a different technical specification may be followed. According to the existing technical specification is followed, when a type2 HARQ codebook is generated while a BWP is switched, the type2 HARQ codebook may not include a HARQ-ACK for a specific serving cell. That is, when considering a time resource (i.e., PDCCH monitoring occasion m) for monitoring a DCI for scheduling a PDSCH, a DCI indicating switching of a DL BWP of a serving cell c in which the terminal receives the PDSCH and a UL BWP of a serving cell to which a PUCCH is to be transmitted should be received earlier than a time m, and a DCI indicating switching of the activated DL BWP should not be detected in the time m. In this case, the terminal may increase c by 1 without including the HARQ-ACK for the corresponding serving cell c in the HARQ codebook. Otherwise, an additional procedure for including the HARQ-ACK in the HARQ codebook may be performed.

The method for the type1 HARQ codebook and/or the type2 HARQ codebook may be extended and applied to a deferred HARQ codebook. In the existing technical specification in which the deferral is not supported, when two or more SPS PDSCHs are received, the SPS HARQ codebook may be generated regardless of the switching of the BWP. However, when the deferral is supported, a valid time may be configured differently for each SPS or the BWP may be switched, and thus a case where the HARQ-ACK is no longer needed may occur.

Considering the SPS, based on a time when the DCI for switching the BWP is received, a HARQ-ACK for a previously received SPS PDSCH (or a serving cell from which the corresponding SPS PDSCH is received) may not be reported. Alternatively, it may be interpreted that deferral of the SPS HARQ-ACK is stopped by the switching of the BWP. According to a proposed method, in the procedure of generating the SPS HARQ codebook, HARQ-ACKs may be mapped to the SPS HARQ codebook only when the BWP switching does not occur.

Method E.9-1: When the BWP is switched, the HARQ codebook may not include a HARQ-ACK for a previously received SPS PDSCH.

Method E.9-2: When the BWP is switched, the HARQ codebook may not include a HARQ-ACK for a serving cell from which a SPS PDSCH is received.

Method E.9-3: In Method E.9-1 and Method E.9-2, the HARQ codebook may be a type1 HARQ codebook or a type2 HARQ codebook.

If a certain HARQ-ACK is not included in the HARQ codebook, the size of the HARQ codebook may be reduced. For a HPN corresponding to the missing HARQ-ACK, a HARQ buffer may not be flushed even if the BWP is switched.

### (10) Method for Supporting Repeated Transmission

In order to extend coverage of a PUCCH, the terminal may be indicated to perform UCI repetition. The number of repetitions may be determined for each PUCCH format or a value determined for each PUCCH resource. The PUCCH may be transmitted in one slot, and the number of repetitions may be indicated through RRC signaling or a DCI.

The repetition may be configured even when an SPS HARQ-ACK is transmitted. Also, when operating in the TDD mode, a deferral operation in which the SPS HARQ-ACK is transmitted in a first valid slot instead of a slot indicated to the terminal may be performed together with the repeated transmission operation. For example, when four repeated transmissions are configured, four slots that may be non-contiguous may be selected, and the PUCCH may be repeatedly transmitted in the four slots.

When a maximum deferral time (k1off,max) of the SPS is configured to the terminal, a valid slot derived by the terminal may be limited within a specific time.

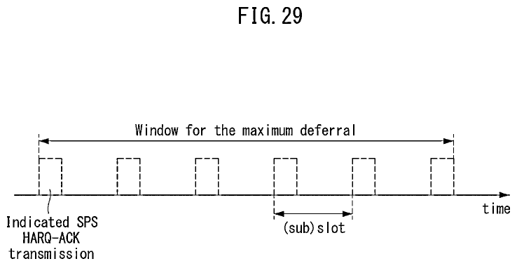

FIG. 29 is a conceptual diagram illustrating an exemplary embodiment of a time resource in which an SPS HARQ-ACK can be transmitted.

Referring to FIG. 29, the terminal may intend to transmit a HARQ-ACK in a slot after k1 slots from a slot in which an SPS PDSCH is received, but when the corresponding slot is an invalid time resource due to an indicated slot pattern, etc., the terminal may transmit the HARQ-ACK in a valid time resource thereafter.

The HARQ-ACK may be preferably transmitted earlier than k1+k1off,max. That is, it may be meaningful to the base station that the HARQ-ACK is received within a time window.

Here, even when the HARQ-ACK is repeatedly transmitted, it may be preferable that the HARQ-ACK is received within the time window. In this case, the terminal may perform repeated transmissions less than the indicated number of repetitions.

Method E.10-1: The terminal may defer the SPS HARQ-ACK only within a time window. Method E.10-2: When the terminal performs repeated transmission, the terminal may transmit the SPS HARQ-ACK only within a time window.

When using Method E.10-1, a first instance of PUCCH instances transmitted by the terminal may belong to a time window. When using Method E. 10-2, a last instance of the PUCCH instances transmitted by the terminal may belong to the time window. In this case, the number of instances that the terminal actually transmits may be smaller than the number indicated by the number of repetitions.

This may be easily applied when the SPS HARQ-ACK is 1 bit (or when one SPS configuration exists). If two or more SPS configurations exist or two or more SPS PDSCHs correspond to SPS HARQ-ACKs, it may difficult to apply Methods E. 10-1 and E. 10-2 as they are. The reason is that although the SPS HARQ-ACK bits need to be multiplexed and transmitted in form of the HARQ codebook, k1 offsets or time windows of the SPS HARQ-ACK bits may be different.

When a plurality of SPS PDSCHs are received, SPS HARQ-ACK bits for the respective SPS PDSCHs may be derived. However, according to a certain TDD slot pattern, the SPS HARQ-ACK bits may not be transmitted. These may deferred up to a first valid time resource, and may be multiplexed in the same slot. Here, a case in which repeated transmission is performed may be considered.

Since repeated transmission can be performed in consideration of a time window, it may be preferable that the terminal determines one time window from among time windows that can be considered for the respective SPS HARQ-ACK bits, and transmits the HARQ-ACKs (or HARQ codebook) within the selected time window.

Method E.10-3: The earliest ending time window or the last ending time window may be utilized.

When the number of repeated transmissions is determined based on the earliest ending time window, a reception quality of the HARQ-ACK may be deteriorated for other SPS PDSCHs other than the first received SPS PDSCH. Therefore, it may be preferable to determine the number of repeated transmissions based on the last ending time window. Since a valid time is different for each SPS HARQ-ACK, the base station may need to take this into consideration and perform decoding by using only a part of the repeated PUCCHs.

A PDSCH allocated not only by the SPS but also by a DCI may be received. When the HARQ codebook is generated using the HARQ-ACKs generated at this time, only the time window corresponding to the SPS HARQ-ACKs may be considered. That is, the length of the time window corresponding to the HARQ-ACK (DS HARQ-ACK) for the PDSCH allocated by the DCI may be considered to be infinitely large, or the consideration of the time window may be limited to the SPS HARQ-ACKs.

In addition, a time window may not be configured for a certain SPS configuration. In this case, it may be interpreted that the length of the time window is infinitely large as in the DS HARQ-ACK, or it may not be considered as an SPS configuration for which the time window is considered.

Method E.10-4: In case of the DS HARQ-ACK and the SPS HARQ-ACK corresponding to the SPS configuration for which a time window (or k1off,max) is not configured, it may be assumed that the length of the time window is infinite or an operation based on the time window may not be performed.

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
receiving, from a base station, a semi-persistent scheduling (SPS) physical downlink shared channel (PDSCH);
receiving a first PDSCH from the base station;
generating SPS hybrid automatic repeat request (HARQ) acknowledgment (ACK)/negative ACK (NACK) information for the SPS PDSCH;
generating first HARQ ACK/NACK information for the first PDSCH; and
when the SPS HARQ-ACK/NACK information is not transmitted in a first slot and transmission of the SPS HARQ-ACK/NACK information is deferred, transmitting both the SPS HARQ ACK/NACK information and the first HARQ ACK/NACK information in a second slot after the first slot.

2. An operation method of a base station in a communication system, the operation method comprising:
transmitting, to a terminal, a semi-persistent scheduling (SPS) physical downlink shared channel (PDSCH);
transmitting a first PDSCH to the terminal; and
when SPS hybrid automatic repeat request (HARQ) acknowledgment (ACK)/negative ACK (NACK) information for the SPS PDSCH is not received from the terminal in a first slot and reception of the SPS HARQ-ACK/NACK information is deferred, receiving both the SPS HARQ ACK/NACK information and first HARQ ACK/NACK information for the first PDSCH in a second slot after the first slot.
